(19) United States
(12) Patent Application Publication
(10) Pub. No.: US 2014/0072945 A1
(43) Pub. Date: Mar. 13, 2014

(54) Method and a system to deliver a live and instant interactive school experience over a plurality of learning sites at different locations, such locations being broadcast simultaneously to a plurality of cohort or individual learners at different locations throughout a network.

(71) Applicants: Lawrence Gu, Burnaby (CA); Heping Shang, Walnut Creek, CA (US); Bing An, Surrey (CA); Wenmin Qi, Beijing (CN)

(72) Inventors: Lawrence Gu, Burnaby (CA); Heping Shang, Walnut Creek, CA (US); Bing An, Surrey (CA); Wenmin Qi, Beijing (CN)

(21) Appl. No.: 13/607,784

(22) Filed: Sep. 9, 2012

(51) Int. Cl. G09B 3/00

(52) U.S. Cl. 434/350

(57) ABSTRACT

A system for delivering distance learning enables a plurality of teaching sites to be streamed to multiple locations via a network with instant, real time information conveyance and instant interaction between at least one teacher at least one of said teaching sites and at least one learner at least one learning site via video images, audio signals, whiteboard functions, and other text chat messaging and other digital signal modes.

### FIELD OF THE INVENTION

This invention relates to improvements in distance learning over a multi-user network. More specifically, the present invention relates to the delivery of a learning experience of one traditional live classroom or live classroom of plurality simultaneously and coordinately over a network.

### BACKGROUND OF THE INVENTION

Broadband in the North American market has grown beyond critical mass and is now in over 23 million homes. The percentage of households that have broadband in the US is over 18 percent and growing. This broadband penetration has spawned multiple new rich media offerings on the Internet such as short movies, animation clips, previews of theatrical releases, commercials, television broadcasts, and downloads of traditional audio/video content.

While education is one of the most important components to supply the required human capital for the economic prosperity, it has been becoming a huge financial liability not only for governments but also for individual students/learners. The greatest portion of educational cost is spent on classroom delivery in an expensive, sometimes impractical, traditional format. As Internet gains popularity and the uses and acceptance of social media grows, online learning has also exponentially grown over the few years.

The market for distance learning offerings will strongly benefit and develop from this broadband penetration in a multitude of ways. Firstly, educational content can leverage the customization abilities offered by the Internet much more than conventional media products since the resolution quality is relatively less important in the educational videos, making them more conductive to web based distribution than any of the entertainment oriented offerings. Secondly, students today are highly comfortable with computers and the internet. Thus, rich media based learning over the internet can help expand the education market substantially by offering consumers the ability to learn when they want and where they want.

Still, there are recognized challenges:
online learning environment tends to isolate a student learning so it only works for a portion of learners who can study under this circumstance;
the quality of learning has been reported that is not as high as the traditional face to face teaching-learning environment (hence, there is a reluctance to rate it at par to in person delivery of information), largely arising from the lack of monitoring and surveillance pressure from the instructor on the learners;
there are only a portion of the instructors are capable of designing and delivering teaching materials distributed through an online format. While many instructors may be expert in the subject matter but not well trained in using internet for their delivery of teaching;
the existing online education does not provide instant dialogue between the instructor and the learners, thus limiting the application of the use of internet for many subject matters that require interactions throughout the learning process;
a weakness is also acknowledged that existing online education does not provide a learning environment that can combine the theory teaching with the laboratory hands-on practice together, of the latter, which plays an important role in training practitioners, technical, and vocational individuals;
the North American pedagogy requires occasional group learning environment in a traditional classroom under the instructor's monitoring. This effective tool for learner's engagement has been limited in the existing online learning platform.
Last but not least, some online teaching is delivered based on the social media network platform that poses extensive risks with learner's information that many educational organizations are liable for securing these data as required by the government regulations.

It is an object of the present invention to obviate or mitigate all of the above disadvantages.

### SUMMARY OF THE INVENTION

The present invention provides a system for delivering distance learning which enables a plurality of teaching sites to be streamed to multiple locations via a network with instant, real time information conveyance and instant interaction between at least one teacher at least one of said teaching sites and at least one learner at least one learning site via video images, audio signals, whiteboard functions, and text chat messaging and other digital signal modes which comprises:

a) a first teaching site with screen content on an website interface (first screen content);

b) more than one additional teaching site with screen content on a website interface (secondary screen content, tertiary screen content . . . );

c) more than one learning site at remote locations from both the first teaching site and the additional teaching sites, said learning sites enabled to i) receive information conveyed from the first teaching site and the additional teaching sites and ii) send information back to the first teaching site, the additional teaching sites and the learning sites;

d) a server (or a series of servers, forming a “server system”) for managing registration and log in via the network, of first teaching site, additional teaching sites and learning sites to the website, synchronizing information, real time conveyance of information from, content delivery to and from and interaction and communication by and between:
i) the first teaching site to the learning sites
ii) the first teaching site to the additional teaching sites
iii) the additional teaching site to the learning sites;
iv) the additional teaching sites to the first teaching site;
v) the learning sites to the first teaching site and more than one additional teaching sites;
vi) between the additional teaching sites; and
vii) between one learning site and other learning sites.
   wherein a learning site is transformable from a passive learning state to an active learning state in relation to both the first teaching site and the additional teaching sites, such transformation being controllable and dynamically alterable by at least one of the first teaching site and the additional teaching sites;
   wherein a learning site in the active learning state i) has screen content on the website interface (active learning site screen content), such active learning site screen content being viewable by a teacher at one of the first teaching site and more than one additional teaching sites and ii) is enabled to actively engage with the first teaching site and more than one additional teaching sites via at least one of the following, alone or in combination: instant communications through two way video images, audio signals, whiteboard functions, and text chat messaging.

The present invention further provides a computer implemented method for delivering distance learning which enables a plurality of teaching sites to be streamed to multiple locations via a network with instant, real time information conveyance between at least one teacher at at least one of said teaching sites and at least one learner at at least one learning site via video images, audio signals, whiteboard, and other messaging modes which comprises:

a) connecting, via a network, and with permission of a server system, a first teaching site, more than one additional teaching site (said additional teaching sites at remote locations from the first teaching site) and more than one learning site (said learning sites at remote locations from both the first teaching site and the additional teaching sites);

b) providing dynamic live data from the first teaching site to the additional teaching sites and the learning sites in accordance with requests to the server system;

c) providing dynamic live data from the additional teaching sites to the first teaching site and the learning sites in accordance with requests to the server system;

d) providing dynamic live data from the learning sites to the first teaching site and the additional teaching sites in accordance with requests to the server system;

e) synchronizing information, real time conveyance of information from, content delivery to and from and communication by and between:
i) the first teaching site to the learning sites
ii) the first teaching site to the additional teaching sites
iii) the additional teaching sites to the learning sites;
iv) the additional teaching sites to the first teaching site;
v) the learning sites to the first teaching site and the additional teaching sites;
vi) between one additional teaching site and another additional teaching site; and
vii) between one learning site and other learning sites.

f) transforming at least one learning site from a passive learning state to an active learning state in relation to at least one of the first teaching site and the additional teaching sites, such transformation being controlled and dynamically altered by at least one of the first teaching site and the additional teaching sites, wherein a learning site in the active learning state i) has screen content on a website interface (active learning site screen content), such active learning site screen content being viewable by a teacher at least one of the first teaching site and the additional teaching sites and ii) is enabled to actively engage with the first teaching site and the additional teaching sites through at least one of the following, alone or in combination: real-time video, whiteboard, audio and text chat interactions.

In another aspect, the present invention provides a method of monitoring a learner at a learning site by one or more of the first teaching site, the additional teaching sites and other learning sites which comprises enabling surveillance of the learners via an image capture device, capturing live images of the learners from the image capture device and conveying such live images, via a server or server system to the first teaching site, the additional teaching sites and other learning sites, such live images being viewable on an interface at each site.

The present invention further provides a computer implemented method for connecting at least one learner at a learning site seeking deliverance of live distance learning data simultaneously from a teacher at first remote teaching site and a teacher at more than one remote teaching sites, such data being coordinated in its delivery between the first remote teaching site and the remote teaching sites and the learning sites which comprises:

a) receiving, from the first teaching site, requests to establish electronic relationships with more than one additional teaching sites and more than one learning sites;

b) providing data corresponding to the requests to a server system; and

c) receiving from the server system live (dynamic or static) data and communications provided by the first teaching site, the additional teaching sites and by the learning sites, wherein the data and communications have been selected by the server system to be delivered in real time only by and between those sites which have requested and accepted relationships.

The present invention further provides a networked apparatus for use by at least one learner at a learning site in live communication for receiving data coordinated from a plurality of remote teaching sites comprising: a memory; a processor; a communicator; a display; a data receiving module to receive (alone or in combination) video images, audio signals, whiteboard, and text chat messages from the teaching sites, via a central server system, and an image capture device which creates a learner site image, and wherein the apparatus comprises a means to convey the learning site image to the server system, via a network, said learner site image being intermittently viewable on a website interface to both the teaching sites and a plurality of learning sites.

The present invention further provides a networked apparatus for use by at least one teacher at a teaching site in live communication for sending data to a plurality of remote learning sites and additional teaching sites comprising: a memory; a processor; a communicator; a display; a data sending and receiving module to send and receive at least one of the following, alone or in combination: video images, audio signals, whiteboard and text chat messages, via a central server system, to a plurality of remote learning sites and additional teaching sites, a display for receiving, via the server system, images captured from at least one learning site and a website interface to toggle a learning site between an active learning state and a passive learning state, wherein said active learning state provides for: i) interaction between the learning site and a teacher at least one of the first teaching site and the at least one additional teaching site via two-way video images; ii) interaction between the learning site and with a teacher at least one of the first teaching site and the at least one additional teaching site via two-way audio; iii) interaction between the learning site and with a teacher at least one of the first teaching site and the at least one additional teaching site via whiteboard communication; and iv) interaction between the learning site and with a teacher at least one of the first teaching site and the at least one additional teaching site via text chat messaging.

The present invention further provides a non-transitory, computer-readable storage media for tangibly storing thereon computer readable instructions for a method for delivering distance learning which enables a plurality of teaching sites to be streamed to multiple locations via a network with instant, real time information conveyance between a teacher at least one of said teaching sites and a learner at a learning site via video images, audio signals, and other messaging modes which comprises:

a) connecting, via a network, and with permission of a server system, a first teaching site, more than one additional teaching site (said additional teaching sites at remote locations from the first teaching site) and at least one learning site (said learning site at a remote location from both the first teaching site and the additional teaching sites);

b) providing dynamic live data from the first teaching site to the additional teaching sites and the learning site in accordance with requests to the server system;

c) providing dynamic live data from the additional teaching sites to the first teaching site and the learning site in accordance with requests to the server system;

d) providing dynamic live data from the learning sites to the first teaching site and the additional teaching sites in accordance with requests to the server system;

e) synchronizing information, real time conveyance of information from, content delivery to and from and communication by and between:
i) the first teaching site to the learning sites;
ii) the first teaching site to the additional teaching sites;
iii) the additional teaching site to the learning site;
iv) the additional teaching sites to the first teaching site;
v) the learning site to the first teaching site and the additional teaching site;
vi) between additional teaching sites; and
vii) between one learning site and other learning sites.

f) transforming the learning site from a passive learning state to an active learning state in relation to at least one of the first teaching site and the additional teaching sites, such transformation being controlled and dynamically altered by at least one of the first teaching site and the additional teaching sites, wherein a learning site in the active learning state i) has screen content on a website interface (active learning site screen content), such active learning site screen content being viewable by a teacher at least one of the first teaching site and the additional teaching sites and ii) is enabled to actively engage with the first teaching site and the additional teaching sites through at least one of the following, alone or in combination: real-time video, audio, whiteboard and text chat interactions.

The present invention further provides an interface which is viewable by participants at an observer site, such observer site being optionally non-viewable on said interface by other participants (teaching and learning sites) and controlled by a server or sever system.

The present invention further provides an interface for teaching sites and learning sites to selectively view a particular learning site using an image capture device at said particular learning site.

The present invention further provides an interface which is viewable by participants at a first teaching site, an additional teaching site and a learning site (wherein those sites are networked to engage with a server) wherein said interface comprises:
a module (a segment of the interface) for display of live content delivered from the first teaching site, such content being viewable by all participants (primary teaching site display module)
one or more modules (segment of the interface) for display of live content delivered from each additional teaching site(s), such content being viewable by all participants (each a secondary teaching site display modules)
a module (a segment of the interface) for display of live content delivered from an active learning site such content being viewable by all participants (each a learning site display module).

The present invention provides a method and a system which enable a plurality of learning sites, which may be traditional classrooms or other innovative in situ training, teaching or laboratory environments to be streamed live and simultaneously to multiple locations via the internet or intranet or the combination of both with instant, real time interaction between teachers and learners via at least one of the following, alone or in combination: video images, audio signals, whiteboard functions, and text chat messages.

The advantages of this method and system are significant. The traditional format of learning through internet is improved upon and therein removes the typical restrictions of online education which conventionally create an isolated environment for a learner. Importantly, the present invention does not require fixed equipment to be installed in a teaching site (for example a lecture hall) so that both the primary and additional teaching sites can be chosen anywhere as long as, at each location, there is a network connection (via internet or intranet), a computer and an image capture device (for example a camera built into a computer).

This system can be installed within the needs of any organization so that it does not rely any third party platform. This can be critical and previously hindered/prevented educational organizations such as an institution, or a school board from fully using distance educational tools due to regulations and restrictions on the security of learner's information.

These and other advantages of the invention will become apparent throughout the present disclosure.

### BRIEF DESCRIPTION OF THE FIGURES

FIG. 1 illustrates a schematic diagram of a computer architecture that may be used to implement the present invention;

FIG. 2 illustrates a flow diagram depicting the operation of the system of the present invention;

FIG. 3 is an illustration of an interface layout for a teaching site interface, in multiple live teaching sites (modes);

FIG. 4 is an illustration of an interface layout for a teaching site interface, in multiple teaching with prepared content mode;

FIG. 5 is an illustration of an interface layout for a teaching site interface, in multiple teaching site with learning management mode;

FIG. 6 is an illustration of an interface layout for a teaching site interface, in single teaching mode;

FIG. 7 is an illustration of an interface layout for a teaching site interface, in a single teaching site with prepared content “show” mode;

FIG. 8 is an illustration of an interface layout for a learning site interface, showing active vs passive learning sites;

FIG. 9 is an illustration of an interface layout for cohort discussion mode;

FIG. 10 is a screenshot of an interface layout for a teaching site interface, in multiple live teaching sites (modes);

FIG. 11 is a screenshot of an interface layout for simultaneously screening of a lecture at a first teaching site and a lab at an additional teaching site;

FIG. 12 is a screenshot of an interface layout for simultaneous teaching/data conveyance from a first teaching site and four additional teaching sites;

FIG. 13 is a screenshot of an interface layout for learner surveillance at two active learning sites;

FIG. 14 is a screenshot of an interface layout for a PowerPoint Slideshow at the first teaching site;

FIG. 15 is a screenshot of an interface layout for a synchronization protocol; and

FIG. 16 is a screenshot of an interface layout for a video playing at the first teaching site, and with four locations of additional teaching sites.

### DETAILED DESCRIPTION OF THE INVENTION

A method, system and apparatus for the efficient, real time delivery of a live school experience over a plurality of teaching sites at different remote locations, such locations being broadcast simultaneously to a plurality of cohort learner(s) at different locations throughout a network or networks. A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Unless specifically stated otherwise, it is appreciated that throughout the description, discussions utilizing terms such as “processing” or “computing” or “calculating” or “determining” or “displaying” or the like, refer to the action and processes of a data processing system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays with the applications described herein are not inherently related to any particular computer or other apparatus. Various general-purpose systems may be used with programs in accordance with the teachings herein, or it may prove convenient to construct more specialized apparatus to perform the required machine-implemented method operations. The required structure for a variety of these systems will appear from the description below. In addition, embodiments of the present invention are not described with reference to any particular programming language. It will be appreciated that a variety of programming languages may be used to implement the teachings of embodiments of the invention as described herein.

An embodiment of the invention may be implemented as a method or as a machine readable non-transitory storage medium that stores executable instructions that, when executed by a data processing system, causes the system to perform a method. An apparatus, such as a data processing system, can also be an embodiment of the invention. Other features of the present invention will be apparent from the accompanying drawings and from the detailed description which follows.

The term “invention” and the like mean “the one or more inventions disclosed in this application”, unless expressly specified otherwise.

The terms “an aspect”, “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “device” and “mobile device” refer herein to any personal digital assistants, Smart phones, other cell phones, tablets and the like.

The term “variation” of an invention means an embodiment of the invention, unless expressly specified otherwise. A reference to “another embodiment” or “another aspect” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present application, including anything which may be incorporated by reference”, unless expressly specified otherwise.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example”, and thus does not limit the term or phrase it explains. For example, in a sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

The term “teacher” refers to any individual or group of individuals conveying content. Teacher includes educators, professors, lecturers, instructors, teaching assistants, technicians, and experts in any field of endeavour. The term should be taken very broadly in scope. Within a teaching site, there may be one teacher or more than one teacher.

The term network refers to Internet and intranet connections (or combination of the two).

The term “participant(s)” refer to one, two or more or all learners and teacher/educator/lecturers.

The term “teaching site” is used herein in a broad manner to refer to any site from which a body of educational information and content can be conveyed in theoretical or practical form. It includes traditional classrooms, lecture halls and laboratories but goes significantly beyond these forms. As long as a site is accessible via a network, can be broadcast to learners at learning sites and to other teaching sites, it is fully contemplated as part of the method and system of the present invention. For example, for teaching welding students, it may be helpful to have one teaching site be at a job site, perhaps a building under construction. For marine biology student, it may be helpful to have one teaching site be at a marine research station. For a physics student studying medical isotopes, student, it may be helpful to have one teaching site be at a particle accelerator facility.

With regard to the “teaching site”, method and system of the present invention refer to a first teaching site and additional teaching sites. A significant advantage of the present invention is that a learner at a learning site (remote from either the first teaching site or the additional teaching sites) dynamically and in real time (substantially live, as there may on occasion be a brief time delay) is conveyed information from a teacher at a first teaching site and at least one additional teaching site (most preferably more than one teaching site) via video images, audio signals, whiteboard and other messaging modes. Both teaching sites are delivered to the learner in real time and data is, by the server (or server system) and network, provided to the learner in a coordinated and synchronized form.

This is significant as a learner at a learning site can view, in a coordinated synchronized form, a plurality of subject-relevant or related content designed to enrich the online or distance learning experience. For example, and as described further below, a learner at a learning site may be a medical student. In this example, a first teaching site may be a traditional classroom in which a professor conveys material via one or more conventional delivery modes (speaking, whiteboards, PowerPoint presentations etc. . . . ) To complement the subject matter being conveyed at the first teaching site, a second teaching site is running in parallel from an operating room in which doctors are conducting an operation on a patient. An image capturing device such as a camera provide live feed of the operation and relays this to both the first teaching site and to the learning site (conveyance via the network and server). In this example, a tertiary site is running in parallel from a “mock operating room” with a dummy and several students in a laboratory-like environment. An image capturing device such as a camera provide live feed of the operation and relays this to both the first and second teaching sites and to the learning site (conveyance via the network and server). In this example, a parallel quaternary teaching site is a parallel expert panel discussion. An image capturing device such as a camera provide live feed of the operation and relays this to both the first, second and tertiary teaching sites and to the learning site (conveyance via the network and server). In this example, a quinary teaching site is a live classroom with teaching assistants or other teachers present. In this example, a learning site may be a student's home, in which the student is studying remotely. Such a student may be geographically remote from the first, second, tertiary, quaternary and quinary teaching sites but is part of the network (internet or intranet) through which the website (hosted by a server or server system) is engaged. Such a student views the parallel sessions, which are coordinated by the method and system of the present invention such that one teaching site is not “talking over” another teaching site.

In one preferred aspect a first teaching site conveys theoretical teaching on a subject and additional teaching site comprise practical teaching on that subject and wherein all simultaneously convey coordinated real time information to the learners, the conveyance of which is controlled by the server.

It is to be understood that “simultaneously” in this context does not mean that a first teaching site and additional teaching sites deliver overlapping audio content, which would make hearing either site difficult. While on an interface an additional teaching site is viewable to a learner, it is preferred that only one site is the “lead audio data conveyer” at any one time. There are exceptions to this. For example: if a professor at a first teaching site is a marine biologist explaining whale communications and an additional teaching site in a ship in the ocean with a underwater audio capture system, both audio feeds may preferably be fed to learners completely simultaneously/contemporaneously and not concurrently.

The term “additional teaching site” refers to secondary, tertiary or other higher order numbers of sites, which, together with the first teaching site, deliver educational content to the learning site or learning sites. It is to be understood that there may be one teacher or more than one teacher at the first teaching site and at the additional teaching sites.

The term “learning site” is used herein in a broad manner to refer to any site from which a body of educational information can be received from a teaching site. As long as a site is accessible via a network, can connects to a teaching site via this network and comprises an image viewing interface to display live feed of the teaching sites (conveyance via the network and server/server system), t is fully contemplated as part of the method and system of the present invention.

It is preferred that every learning site is transformable from a passive learning state to an active learning state in relation to at least one of the first teaching site and the additional teaching site, such transformation being controllable and dynamically alterable by at least one of the first teaching site and the additional teaching site. In this way, when a learning site is in an active learning state i) it has screen content on the website interface (active learning site screen content), such active learning site screen content being viewable by a teacher/educator/lecturer at least one of the first teaching site and the at least one additional teaching site and ii) is enabled to actively engage with the first teaching site and the at least one additional teaching site by at least an interactive audio/visual stream.

For greater clarity, with respect to a learning site, being in an active learning state means that it (and learners therein) can be seen and monitored by at least one teaching site (generally by a teacher/educator/lecturer therein). Being in an active learning state is important for at least two reasons: 1) learners therein may actively engage teachers/educators/lecturers within the teaching sites and have “real time” interactions with them, questions and answers, reciprocal and instant feedback etc. . . . ), particularly via video feeds; and 2) learners therein may be monitored, identified and placed under surveillance during tests, exams etc. . . . The level of visibility is preferably such that a learner in an active site may even raise his/her hand and be identified and selected to talk by teachers at a first teaching site or additional teaching site.

For a learning site, being in an passive learning state means that it may not have real time video interaction with a teaching site. While learners at a passive site will “see” and “view the same feeds as learners at an active learning site, passive site learners are not seen by teachers/educators/lecturers at a teaching site . . . ie “face time” only operates one way. Questions posed and interaction of learners at a passive site may be by other non-video forms such as text chat, emailing or other messaging.

While (generally) fewer sites are “active” learning sites than passive learning sites, it is contemplated that learning sites are “toggled” or switched between active and passive states. The number of passive learning sites may be in the order of one million or more. Within an active learning state, there is a higher level of engagement with the teaching site. This active engagement is direct, live and interactive. Within a passive learning state, there is a lower level of engagement with the teaching site. This distinction forms the basis of one key aspect of the present invention: due to the lower level of engagement, there can be huge numbers of passive learning sites, at any given time (preferably up to one million learning sites). The only limitation on number of passive learning sites is network (whether internet or intranet capacity). There simply could not be an “active” level of engagement with this number of learning sites, simply due to the fact that active sites populate the interface with the learning site display module(s). There is only a finite amount of screen space on each computer screen. In one embodiment, active learning sites are toggled for viewing on the learning site display module.

It is to be understood that there are at least two types of content deliverable from each teaching site upon request of the server system: a) dynamic live data (for example, actual live teachers conveying content verbally and live video feeds) and b) pre-loaded data (for example, content such as PowerPoint presentations, pre-recorded video clips, etc. . . . ).

In regard to one aspect of the invention, there is provided a method of monitoring the learning sites being in the active state which enables the surveillance of the learners via an image capture device, capturing live images of the learners and conveying such live images, via the server system to the first teaching site, the additional teaching sites, and other learning sites, so that such live images being viewable on an interface at the above mentioned sites.

The invention also provides a recording feature that retains the delivery history of the teaching and learning experience in the system as an option in terms of a video on demand. This function allows the learners to choose a recorded history of a live class with learner's interaction by selecting to view the entire or a portion of the class delivery to meet the individual needs of the learners. Although this function does not provide the learners with the live interaction capabilities with the teachers, it is however an invaluable option for learners with different learning abilities or availabilities at their own pace and choice. This invention therefore perfects the true learning platform for anyone to learn at any time, anywhere in the world.

The invention also provides a observation feature such that teaching sites can be monitored for quality, content etc. . . . by an observer (for example, administrator). Optionally learning sites may also be monitored in this way. It is preferred that there is observer monitoring is not visible to participants.

There is a need to provide a distance learning option which allows for “mass” real time data/information delivery. For this reason, with the scope of the present invention, two engagement systems are used to interact or connect learning sites to teaching sites. By “switching” the systems or toggling them between active and passive states, a learning site may be simply and easily converted from passive to active. In one aspect, this switching is initiated by a teacher at a teaching site requesting the server to “switch site X” either by his/her own initiative or by request of a learner at a passive learning site through activation of the built-in “Raising Hand” function. In yet another aspect, this switching is initiated based upon pre-programmed criteria: alphabetically based on learner names, geographically based on learner locations; learner ages, degree of experience in subject matter, test scores etc. . . . This list is not exhaustive. In yet another aspect, this switching is randomly initiated. In these last two aspects, the switching is designed to provide a monitoring process which allows learner behaviors to be viewed by the teaching sites as well as other learning sites so as to enable the online learning system to simulate a traditional face to face classroom environment.

It is to be understood that, for the live real time data conveyance it is preferred to have an appropriate bandwidth to support this. The speed with which data may be transmitted is bandwidth dependent. As technology improves in regards to bandwidth, speed of data conveyance to both active and passive learners increases.

This visibility between teaching sites and learning sites (whether active or passive) is achieved by a proprietary device interface, in accordance with the present invention and as described further herein by text and figures.

In particular, within the scope of the present invention, there is provided an interface which is viewable by participants at a first teaching site, an additional teaching site and a learning site (wherein those sites are networked to engage with a server). The interface comprises:
a module (a segment of the interface) for display of live content delivered from the first teaching site, such content being viewable by all participants (primary teaching site display module);
one or more modules (segment of the interface) for display of live content delivered from additional teaching site(s), such content being viewable by all participants (each a secondary teaching site display module); and
a module (a segment of the interface) for display of live content delivered from an active learning site such content being viewable by all participants (each a learning site display module).
The primary teaching site display module is preferably the most prominent of all modules on the interface. With this in mind, it is preferred, in one aspect of the present invention that an additional teaching site is transformed from a secondary teaching site display module to a primary teaching site display module when live content from the additional teaching site is to be delivered. What this means for practical purposes is that, in the coordinated live delivery of content from, for example, a first teaching site and four additional teaching sites, one teaching site is, at any given time, the focal point for such delivery and occupies the primary teaching site display module on the interface. When the focal point for delivery toggles to another teaching site (whether that be the first teaching site or additional teaching sites) that other site occupies the primary teaching site display module on the interface, and so on.

In one aspect of the present invention, an active learning site may be transformed into an additional teaching site so that content can be viewed on the primary teaching site display module and/or secondary teaching site display module.

In operation, sites are networked to engage with a server generally by participants ab initio (first time only) registering to participate via a server. Subsequently, sites are engaged with the server by logging in, providing a username and passwords upon prompting. Preferably, sites are engaged through a website on the internet hosted on a server. Alternatively sites are engaged via an intranet. The latter includes the intranet of educational institutions (for example, universities, colleges etc. . . . ) and organizations (for example, for profit and not for profit).

The interface is viewable by participants on whatever computer/computing device is preferred and includes desktop computers, laptop computers, tablets, mobile Smartphones and the like. For all participants (with the exception of those at passive learning sites which will never be transformed to active learning sites), it is necessary to have engaged with the computing device an image capture device (for example a webcam).

It is preferred that every learning site is transformable between from a passive learning state to an active learning state in relation to at least one of the first teaching site and the additional teaching site, such transformation being controllable and dynamically alterable by at least one of the first teaching site and the additional teaching site. In this way, when a learning site is in an active learning state i) it has screen content on the website interface (active learning site screen content), such active learning site screen content being viewable by a teacher/educator/lecturer at least one of the first teaching site and the at least one additional teaching site and ii) is enabled to actively engage with the first teaching site and the at least one additional teaching site by at least an interactive audio/visual stream.

In one aspect of the present invention, an administrator or other authority or person of oversight may sign in and network with a first teaching site, the additional teaching sites and the learning sites (the “observer site”). The observer site is like a passive learning site in that audio, video and other content is not delivered from the site to other sites. Rather, it is preferably a “silent” site which is used to evaluate the teacher, to monitor progress of the data conveyance or for other administrative roles. In one aspect, the first teaching site, the additional teaching sites and the learning sites would not be aware that a passive site had engaged the network. In this case, the administrator or other authority or person of oversight would have access to network and website setting control.

In one aspect of the present invention, live data conveyed from the first teaching site and the additional teaching sites (as well as participation from active learning sites) is recorded for later viewing by learners who may have missed the real-time delivery or who need to re-learn specific content due to individual learning pace/needs. This function gives the learners flexibility to suit their own learning pace/needs.

In one aspect, non-video forms such as text chat, emailing or other messaging by and between the first teaching site, the additional teaching sites and the learning sites is managed by a teaching assistant or other assistant, particularly in regards to the management of incoming questions to the first teaching site and the additional teaching sites. This feature provides prompt responses to learners at a site in the passive state and also enable the teacher to monitor the feedback from the teaching assistant during the period of teaching delivery.

The term “instant interactivity” is used to refer to the telecommunications between the learners and the instructors and may be initiated by any/either party. In the art, the simulation of a traditional classroom in the online education is hindered largely due to the challenge of the instant “face-to-face” interactions between the instructor and the learners. Within the scope of the present invention, such drawbacks have been overcome.

Any given numerical range shall include whole and fractions of numbers within the range. For example, the range “1 to 10” shall be interpreted to specifically include whole numbers between 1 and 10 (e.g., 1, 2, 3, 4, . . . 9) and non-whole numbers (e.g. 1.1, 1.2, . . . 1.9).

Where two or more terms or phrases are synonymous (e.g., because of an explicit statement that the terms or phrases are synonymous), instances of one such term/phrase does not mean instances of another such term/phrase must have a different meaning. For example, where a statement renders the meaning of “including” to be synonymous with “including but not limited to”, the mere usage of the phrase “including but not limited to” does not mean that the term “including” means something other than “including but not limited to”.

Neither the Title (set forth at the beginning of the first page of the present application) nor the Abstract (set forth at the end of the present application) is to be taken as limiting in any way as the scope of the disclosed invention(s). An Abstract has been included in this application merely because an Abstract of not more than 150 words is required under 37 C.F.R. Section 1.72(b). The title of the present application and headings of sections provided in the present application are for convenience only, and are not to be taken as limiting the disclosure in any way.

The present invention further provides a method and a system to offer a real-time distance-learning platform that forms a plurality of live teaching sites around the world by using the Internet, with such capabilities of comprising video and/or audio feeds and other forms of digital content of the instructors teaching, transmitting the notes being made by teachers on a regular computer whiteboard or on content pre-created in software packages like Microsoft PowerPoint, Adobe Acrobat, Microsoft Excel etc., and also conducting exams, quizzes or give assignments to students to test and/or enhance their performance.

The present invention further provides a method and a system to deliver distance learning which enables a plurality of teaching sites to be streamed to multiple locations connected to a network with instant, real time interactions between the learners and teachers via one or combination of the following: video images, audio signals, whiteboard, and online text chat messaging.

The present invention further provides a method and a system to offer a real-time testing format from a plurality of live learning locations around the world by using the Internet, with such capabilities of video and/or audio feeds of the learners conducting quizzes, tests, and examinations, transmitting the notes or answers being made by learners through computer to reflect the authentic performance of the learners through the online learning system.

The present invention replicates a traditional classroom environment, over a plurality of classrooms at different locations, to the closest extent possible on the Internet or intranet or combination of both by synchronizing the display of white-board, various forms of electronic learning content, and audio and/or video inputs.

The present invention further provides a method and a system to offer distance-learning environment from a plurality of teaching sites around the world by using the Internet, wherein each individual or cohort learners/students may be visually surveyed and monitored via video images and audio signals.

The present invention further provides a method and a system to deliver a live school experience over a plurality of classrooms at different locations, such locations being broadcast simultaneously to a plurality of cohort learners at different locations throughout an internet or intranet (or combination of both) network.

The present invention further provides a method and a system to enable observers or administrators to assess or evaluate the delivery of a live school experience over a plurality of teaching sites being broadcast simultaneously to a plurality of learning sites throughout an internet or intranet (or combination of both) network.

The present invention further provides a system to deliver a live school experience over a plurality of teaching sites at different locations, such locations being broadcast simultaneously to a plurality of cohort and individual learners at different locations throughout either or both of an internet or an intranet network which comprises: a main computing processor connected to a network and comprising a connection application, said processor including a main interface screen at a first teaching location, multiple secondary computing processors comprising a connection application and including an interface sub-screens at secondary teaching locations engaged with the connection application, and a learner computing processor comprising or in communication with a connection application including an interface screen at each location of each individual receiver (learners) and wherein said learner computing processor is networked (via internet or intranet) with at least the main computing processor and optionally one or more secondary computing processors.

Within this system, the main interface screen represents the main teaching site and the multiple sub screens represent the secondary teaching sites for simultaneous delivery with the secondary teaching sites either as a source of broadcasting or a group of learners gathering as a receiving point. In addition, multiple individual learners at remote locations are receiving the delivery of the teaching sites of plurality or observe both the instructor's teaching in the primary teaching site with learners gathered in the secondary sites.

It is also an object of the present invention to enable learners/students to learn anywhere, anytime thus eliminating the effort required on part of learners/students to ensure in person attendance in classrooms while at the same being able to be engaged with the instructor on real-time basis.

It is an object of the present invention to provide a method for offering educational or training format delivered over the internet that focuses on expanding the traditional classroom experience, giving full and real-time access (simultaneously synchronized) to multiple learning sites.

It is an object of the present invention to provide methods of fast, real time, interactive exchanges of information, over multiple teaching sites, in order to best harness the creativity of the large number of people involved in such information relay. Thus, this method is enabled over the internet (or intranet) in a manner that allows teachers to reach out to up to 1,000,000 students outside of their immediate physical surroundings as well as teach them from any location as long as they have certain basic hardware such as a computer, and an internet or intranet connection.

The method and system presented herein frees interactivity from the constraints of location as well as time. While the locational constraints have been removed by other distance learning systems known in the art, where student can interact with the teacher from anywhere, no other system allows dynamic, real time co-teaching such an student or cohort of students, multiple individuals, by more than one teacher, from differing locations.

In one aspect, the present invention provides a primary interaction screen comprising main screen portion representing a main teaching location (for example, the primary teaching site), a plurality of sub-screen portions each representing a different secondary teaching location (for example, secondary teaching sites), and a further plurality of sub-screen portions, each representing individual receivers (learners) at different remote locations (for example, homes, offices, schools, public or private buildings, referred to as learning sites). In other words, the main screen represents the main classroom and the multiple sub screens represent the sub classrooms for simultaneous delivery with the sub classrooms either as a source of broadcasting or a group of learners gathering as a receiving point. In addition, multiple individual learners at remote locations are receiving the delivery of the classes of plurality or observe both the instructor's teaching in the main classroom with teaching assistants gathered in the secondary teaching sites.

In one aspect, the present invention provides a system comprising 1) multiple live teaching sites capable of broadcasting simultaneously with real-time interactions between the instructors and learners; 2) a primary teaching site along with secondary teaching sites at a plurality of different locations, capable of simultaneously or sequentially broadcasting to multiple learners at remote locations; 3) remote learners grouped during a live teaching session into learning cohorts for group discussion while allowing the instructor to monitor each cohort either in a visible or an invisible manner; 4) Obtaining interactive contents or behaviors from the learners and sending the video & audio images back to the instructor(s) in the live teaching sites; 5) Monitor the individual learner's learning mode through the developed surveillance function; 6) Responding to the learners at remote locations with instant interactions via video and audio communications in a similar fashion to the delivery format used in a traditional classroom; 7) providing instant responses by a teaching assistant site (preferably a variation of one of the teaching sites) through online text chat connected with all other teaching and learning sites; 8) allowing Observer(s) or Administrators to audit the teaching and learning either in an invisible or visible manner (to other participants); 9) enable recording of the live delivery session for learners to review at subsequent viewing times.

The present invention provides, in one aspect, a method of dynamically delivering educational content from at least one primary teaching site and secondary teaching sites of plurality, each remote from the other, to learners at different locations. This allows the teaching of theory in the primary site to be combined with hands-on practice demonstration (labs) undertaken in the secondary sites simultaneously to the individual learners at remote locations. Such a platform is extremely useful for practitioner training such as nurses, surgeons as well as vocational technicians such as welders, automobile technicians.

The present invention provides, in one aspect, a unique method, built into the system that allows learners to be divided into passive and active category. The active learning sites are streamed in a similar fashion of the secondary teaching sites and can be viewed by and instantly interact with instructors and other active learning sites via video images, audio signals, whiteboard functions, and text (chat) messages. The passive learners, are able to view the streamed teaching from both teaching sites and the active learner sites, and communicate through text messages. The less “engaged” nature of a passive learning site means the actual number of possible passive learning sites is limited only by the user size of the internet or intranet itself. In addition, in regards to transformation of a passive learning site to an active learning site, a participant at said passive learning site can request (via the website) transformation to become an active learning site. Upon acceptance by a teacher/educator/lecturer at the first teaching site or additional teaching sites (or by an system administrator having authority to do so), the passive learning site is transformed to an active learning site.

The present invention provided a method in which it is used to establish a system that live teaching sites of plurality can be broadcasted simultaneously to many individual learners via the Internet. This invention allows for a group of instructors co-teaching a subject to learners at different locations. Furthermore, the invention enables learners to interact with instructors instantly through functions built in the system that shows raising hands from individual learners.

This invention provides the functions for the instructors with all of the techniques that are often used in the traditional teaching environment, such as using power point presentation, video playing, handing writing through the whiteboard function provided in the system, divide students into groups for cohort based activity, enabling the instructors be easily adapted into this new delivery format that is almost identical to the traditional teaching method.

The invention further provided the capability for instant interactions between learners and instructors in a similar format that often exists in the traditional face to face teaching environment. Once the learner is permitted by the instructor, that individual learning site becomes a secondary teaching site that can be viewed by all of the individual learners. The group can also be viewed by other groups once the instructor activates that function for the selected cohort to demonstrate its work to other groups.

The invention also provided a rotational surveillance function for the instructors to monitor the each learner's status of learning. This function provides a live teaching and learning environment, captured over multiple locations, which eliminates the common challenges that on-line learners are often not monitored during the class delivery.

Furthermore, this invention provided the capability for the learners to learn through a mobile device. The individual learner, upon the instructor's request, can communicate with the instructor through video, voice, writing, handing drawing, like what is carried out in a traditional face to face classroom environment.

This system is built into a computing device and integrated with any existing database system. Such a system would prevent the educational organizations such as a school board or an institution from using the third party platform. This invention would provide a true solution for any educational or training organization to be independent from different regulations on cyber space data management. It also provides the security and integraty of learner's data from being exposed or compromised

The present invention provides a method and a system that allows the streaming of content (audio, visual and data) from a plurality of “traditional” classrooms to multiple viewer/learner/student locations around the world via the internet. There is provided the ability for instant interaction between instructor(s) and learners via video image, audio signals, and text messages. There are provided:
Multiple live classrooms are broadcasted simultaneously with real-time interactions between the instructors and learners;
In each classroom setting, a main classroom along with sub classrooms at different locations are simultaneously or sequentially broadcasted to multiple learners at remote locations;
Remote learners, optionally grouped during the live teaching session into learning cohorts for group discussion while allowing the instructor to monitor each cohort either in a visible or an invisible manner;
Means to obtain interactive contents or behaviors from the learners
Means to send video and audio images back to the instructor(s) in the live classrooms;
Means to monitor individual learner's learning mode through a surveillance function
Ability to respond to learners at remote locations with instant answers in a similar fashion to the delivery used in the traditional classroom.

The present invention provides a system that comprises computing hardware (processor, memory, interface etc. . . . ), software programs and means to engage/communicate/integrate/convey data (audio, visual, text) between and amongst a plurality of teaching locations and learners.

The present invention provides a method and system in which live classes from a plurality of locations can be broadcasted simultaneously to multiple individual learners via internet. This invention allows for a group of instructors co-teaching a subject to learners at different locations. Furthermore, the invention enables learners to interact with instructors instantly through functions built in the system that shows raising hands from individual learners.

This invention provides the functions for the instructors with all of the techniques that are often used in the traditional teaching environment, such as using power point presentation, video playing, handing writing through the whiteboard function provided in the system, divide students into groups for cohort based activity, enabling the instructors be easily adapted into this new delivery format that is almost identical to the traditional teaching method.

The invention further provides the capability for instant interactions between learners and instructors in a similar format that often exists in the traditional face to face teaching environment. Once the learner is permitted by the instructor (via server controls), that individual becomes a teaching site classroom that can be viewed by all of the teaching sites and learning sites. The group can also be viewed by other groups once the instructor activates that function for the selected cohort to demonstrate its work to other groups.

The invention also provided a rotational surveillance function for the instructors to monitor the each learner's status of learning. This function provides a simulated live class environment which eliminates the common challenges that on-line learners are often not monitored during the class delivery.

Furthermore, this invention provided the capability for the learners to learn through a mobile device. The individual learner, upon the instructor's request, can communicate with the instructor through video, voice, writing, handing drawing, like what is carried out in a traditional face to face classroom environment.

### Operation

In the following description, like reference characters designate like or corresponding parts throughout the several views of the drawings:

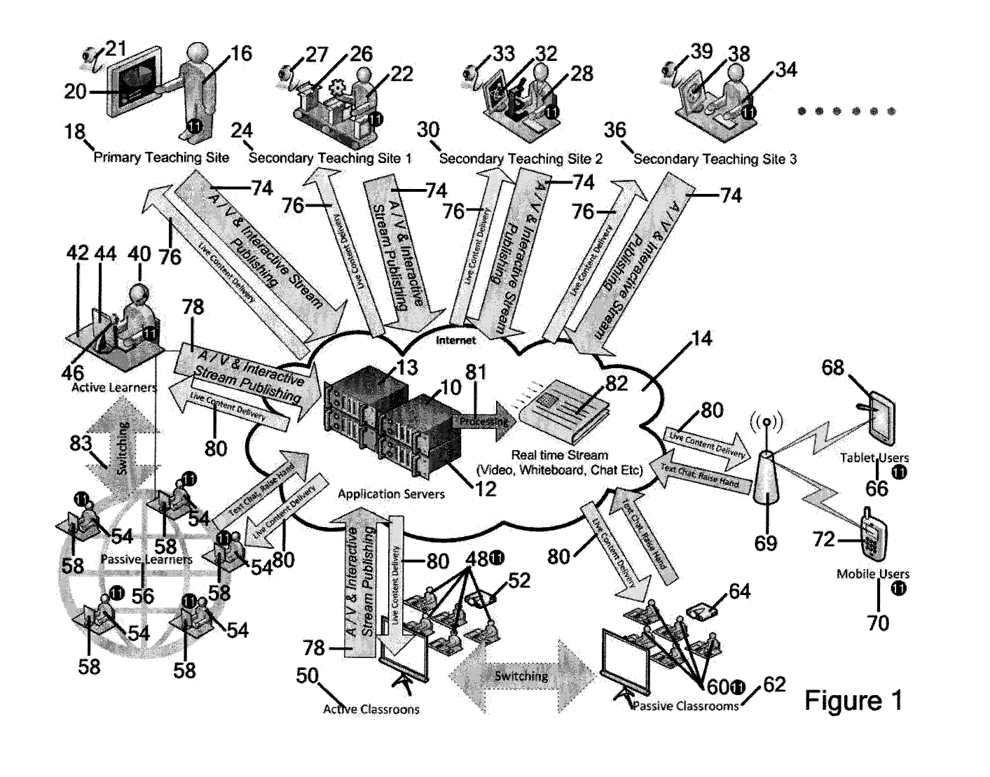

As seen in FIG. 1, the system and method according to the invention are for use with a website 10 operated on application server or servers 12, accessible over the Internet 14 by a plurality of participants and his/her/its microprocessing devices:

Teacher 16, at primary teaching site (18) using computer system 20, with image capture device 21

Teacher 22, at secondary teaching site 1 (24) using computer system 26 with image capture device 27

Teacher 28, at secondary teaching site 2 (30) using computer system 32 with image capture device 33

Teacher 34, at secondary teaching site 1 (36) using computer system 38 with image capture device 39

Active learner 40 (an individual) at learning site 42 using computer system 44 with image capture device 46

Active learners 48 (a group in a classroom) at learning site 50 using computer system 52 with image capture device (not shown)

Passive learners 54 (individuals) at learning sites 56 using computer systems 58 with image capture devices (not shown)

Passive learners 60 (a group in a classroom) at learning site 62 using computer system 64 with image capture device (not shown)

Passive tablet learner 66 using tablet 68 via mobile network 69

Mobile device learner 70 using tablet 72 via mobile network 69

Collectively, all teachers and learners are participants (11).

The website 10 is generally a collection of web pages, hosted on one or more servers 12. Participants 11 may connect to website 10 on the Internet (or via an intranet or via a combination of both) using hyperlinks, also referred to as links. By clicking on a link, a participant 11 directs a browser operating on a computer system to open a window on the monitor of his/her/its respective computer system, thereby showing the website associated with the link.

Typically, on first time use, participants must register with website 10 in order to later join an online, real time learning-teaching environment on website 10. Such a registration system may include obtaining information about the participant such as his/her name, email address, geographic information, such as address, or country of residence, and the like. Once registered, participants can log on to website 10 using a user name and password, which are provided by server 12 or selected by the participant on registration. The participant, in one aspect, may provided a personal landing web page at website 10 at which he/she can display content, course preferences, schedules of classes etc. . . .

Server 12 comprises database 13 which stores the website, the content thereon, associated web pages, records about each participant etc. . . .

Website 10 provides a home web page which may include distance course lists, schedules and the like. Additional information associated with the courses may also be displayed.

When a user participant visits the home page, he/she may log in, if he/she is a registered user. If he/she is not a registered user, he/she may be unable to access certain features of the website, but server 12 records the IP address of the unregistered user, and may offer the unregistered user an opportunity to register.

When a participant registers, he/she obtains an account, and provides, to the system, first name, last name, geographic location (by city or town) and birthday. The system may also request information about the device being used to access the web page, for example the type of computer, the manufacturer of the computer, the browser being used, etc. The participant then selects a password and username for accessing website 10 on subsequent visits.

With reference to FIG. 1, the method according to the invention includes any one or more of the following:

The server 12 (or a series of servers) managing registration and log in via the network, of first (primary) teaching site 18, additional teaching sites 24, 30 and 36 and learning sites 42, 50, 56, 62, 66, and 70 to the website 10, synchronizing information, real time conveyance of information from, content delivery to and from and communication by and between:
i) the first teaching site 18 to the learning sites 42, 50, 56, 62, 66, and 70
ii) the first teaching site 18 to the additional teaching sites 24, 30 and 36
iii) the additional teaching sites 24, 30 and 36 to the learning sites 42, 50, 56, 62, 66, and 70;
iv) the additional teaching sites 24, 30 and 36 to the first teaching site 18;
v) the learning sites 42, 50, 56, 62, 66, and 70 to the first teaching site 18 and more than one additional (secondary) teaching sites 24, 30 and 36; and
vi) between the additional teaching sites 24, 30 and 36

Data or information conveyance by the first teaching site 18 to the additional teaching sites 24, 30 and 36 to server 12 is preferably via audio feed stream, visual feed stream and interactive stream (collectively shown as 74). Live content delivery 76 is provided to first teaching site 18, and one or more additional teaching sites 24, 30 and 36 via server 12. Such live content delivery preferably includes audio and visual feed from active learning sites 42 and 50.

Data or information conveyance by active learning sites 42 and 50 to the first teaching site 18 and to one or more additional teaching sites 24, 30 and 36 via server 12 is preferably via audio feed stream, visual feed stream and interactive stream (collectively shown as 78). Live content delivery 80 is provided to learning sites 42, 50, 56, 62, 66, and 70 from first teaching site 18, and one or more additional teaching sites 24, 30 and 36 via server 12. Such live content delivery preferably includes audio and visual feed from active learning sites 46 and 50.

Passive learning sites 56 and 62, along with passive tablet learner 66 using tablet 68 via mobile network 69 and mobile device learner 70 using tablet 72 via mobile network 69 communicate with the first teaching site 18 and to one or more additional teaching sites 24, 30 and 36 via server 12 by way of, preferably, text chat and simple visual cues such as hand-raising. For the latter, it is required that the passive learning site comprises some type of image capture device, for example a webcam. Finally, FIG. 1 depicts the processing at 81 of a real time stream of data 82 (for example via at least one of the following, alone or in combination: instant communications through two way video images, audio signals, whiteboard functions, and text chat messaging etc. . . . ) which is processed by server 12 and distributed in accordance with the present invention.

In one critical aspect of the present invention, passive learning site 56 is transformed from a passive learning state to an active learning state in relation to both the first teaching site 18 and the one or more of the additional teaching sites 24, 30 and 36 by way of switch process 83, managed by server 12. Likewise, passive learning site 62 is transformed from a passive learning state to an active learning state in relation to both the first teaching site 18 and the one or more of the additional teaching sites 24, 30 and 36 by way of switch process 83, managed by server 12. As noted herein, various participants can trigger, initiative, toggle and control this transformation.

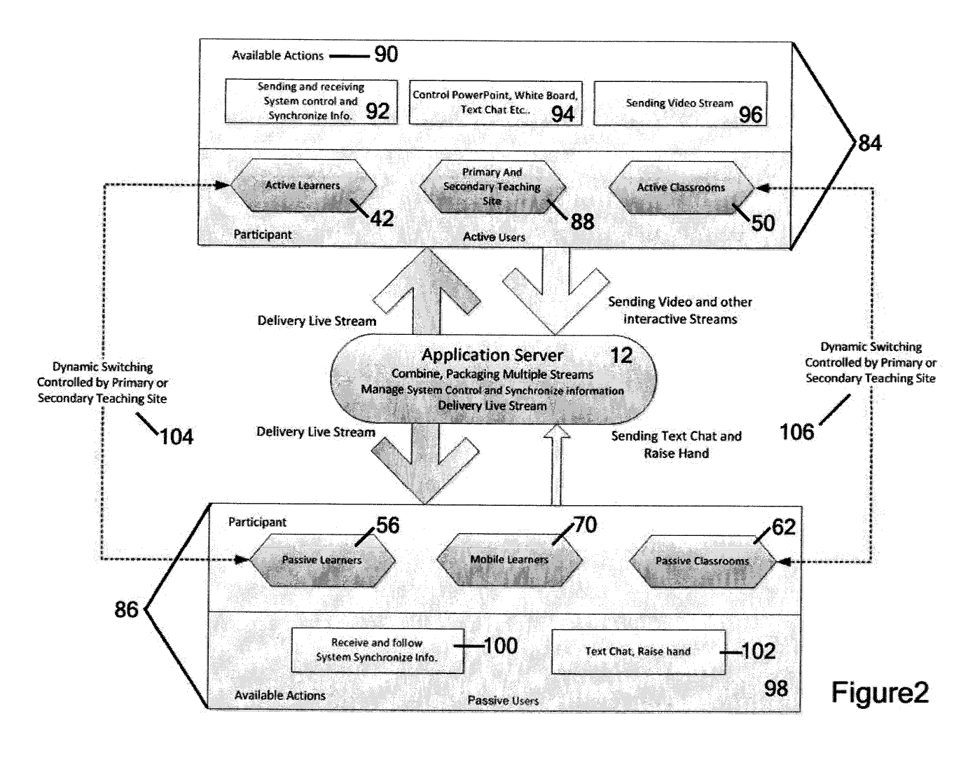

FIG. 2, using the same numerals corresponding to FIG. 1, exemplifies the components of the system and specifically depict one key aspect of the present invention: the dynamic switching of a learning site from a passive learning state to an active learning state. Application server 12 combines and packages multiple data streams, manages and controls and synchronizes information and data and delivers live data streams.

Block 84 comprises all “active sites”. Within this block are: active learning site 42, active classroom 50 as well as first teaching site 18, and additional teaching sites 24, 30 and 36 (all collectively primary and secondary teaching sites 88). Sub-bar 90 of block 84 graphically illustrates the actions and activities available to active sites. These include: sending and receiving, system control, and information synchronization (92); control of PowerPoint, Whiteboard, text, chat and other data communications (94) and sending video stream (96).

Block 86 comprises all “passive sites”. Within this block is learning site 56, mobile learning site 70 and passive classrooms 62. Sub-bar 98 of block 86 graphically illustrates the actions and activities available to passive sites. These include: receive and follow and, system/information synchronization (100); text, chat and raise hand (102).

Switching of passive learning site 56 to an active state at 104 (making such site an equivalent to active learning site 42) occurs by dynamic switching of “site status”, such switching being controlled by processors at a primary (first) or additional teaching site (for example, secondary teaching site).

Switching of passive learning classroom 62 to an active classroom 50 at 106 (making such site an equivalent to active learning classroom 50) occurs by dynamic switching of “site status”, such switching being controlled by processors at a primary (first) or additional teaching site (for example, secondary teaching site).

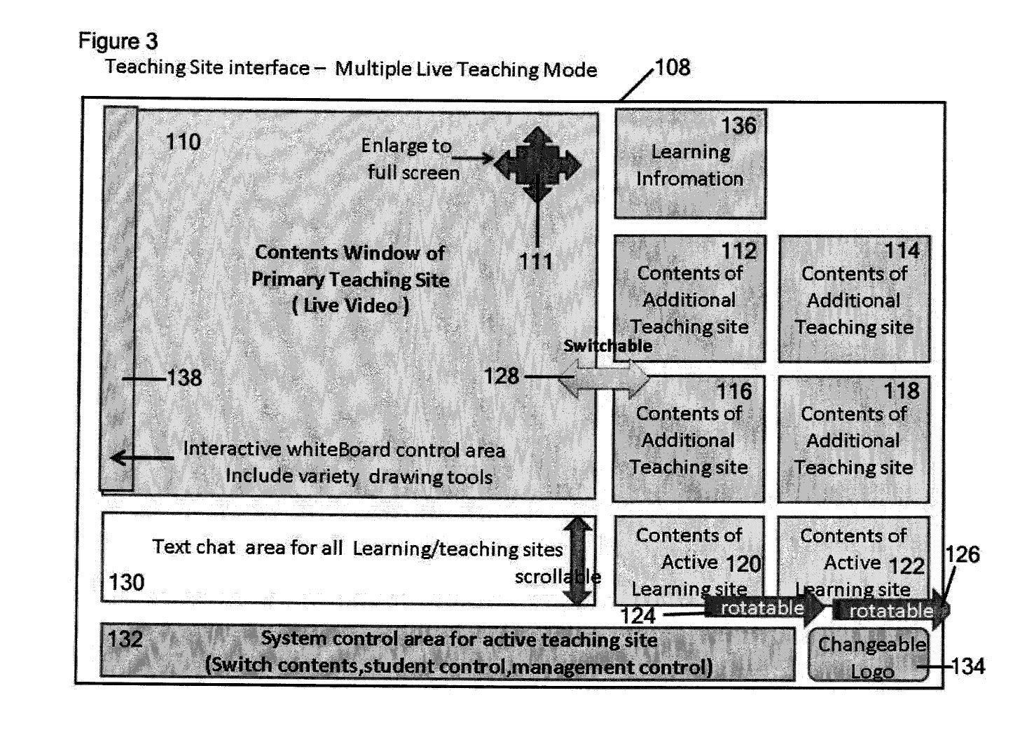

FIGS. 3-9 exemplify preferred website interfaces, viewable by participants and enabling viewing of content and operation of the method and system of the present invention. Such interfaces are accessible by registering and then subsequently logging onto the website, as described herein.

FIG. 3 is an illustration of a teaching site interface, generally at 108, with multiple teaching sites in “live mode”. A module (one segment of the interface) displays live content delivered from the first teaching site 18, such content being viewable by all participants (primary teaching site display module 110). Icon 111 permits enlarging or reducing screen size. In this embodiment, there are four additional live teaching sites. Each has its own module (one segment of the interface) displaying live content delivered from each of the additional teaching sites (secondary teaching site display modules 112, 114, 116 and 118). In this embodiment, there are two viewable active learning sites. Each has its own module (one segment of the interface) displaying live content delivered from each of the active learning sites (120, 122). Arrows 124 and 126 depict that these interfaces are rotatable to bring onto interface 108 images from other active learning sites. Arrow 128 depicts that any of the additional teaching sites can “toggle” into the primary teaching site display module 110 (also referred to as the content window for the primary teaching site). In other words, content from any of 112-118 can toggle into module 110 for larger and more primary viewing.

Bar 130 provides a scrollable text and chat interface. Bar 132 provides a system control area for primary teaching site to switch content, switch learning mode control, and for general content management. Quadrant 134 is a brandable area of interface 108. Module 136 provides other learning information. Band 138 provides a control area for functions within whiteboard, including, for example, drawing tools.

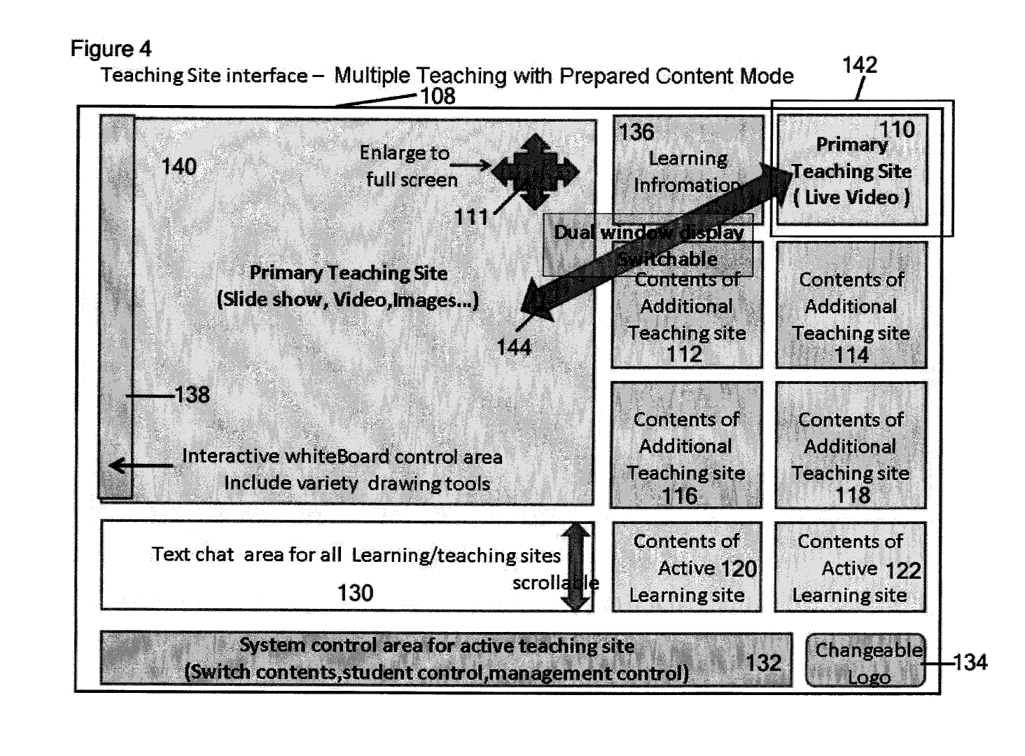

FIG. 4 is similar to FIG. 3 and depicts an additional toggling function at the control of the primary (first) teaching site between live teaching mode (generally the image of a teacher) and a content mode (generally PowerPoint, Slideshow, Video Display or other such data conveyance technologies). So, in this way, primary teaching site display module 110 (live content) switches with primary teaching site display module 140 (content mode). In a preferred form, primary teaching site display module 110 does not disappear as primary teaching site display module 140 (content mode) becomes more prominent on interface but rather toggles to a secondary position 142 adjacent to secondary teaching site display modules 112, 114, 116 and 118. In this way, as shown by arrow 144, window content display is “switchable” or capable being toggled between two viewing states on said interface.

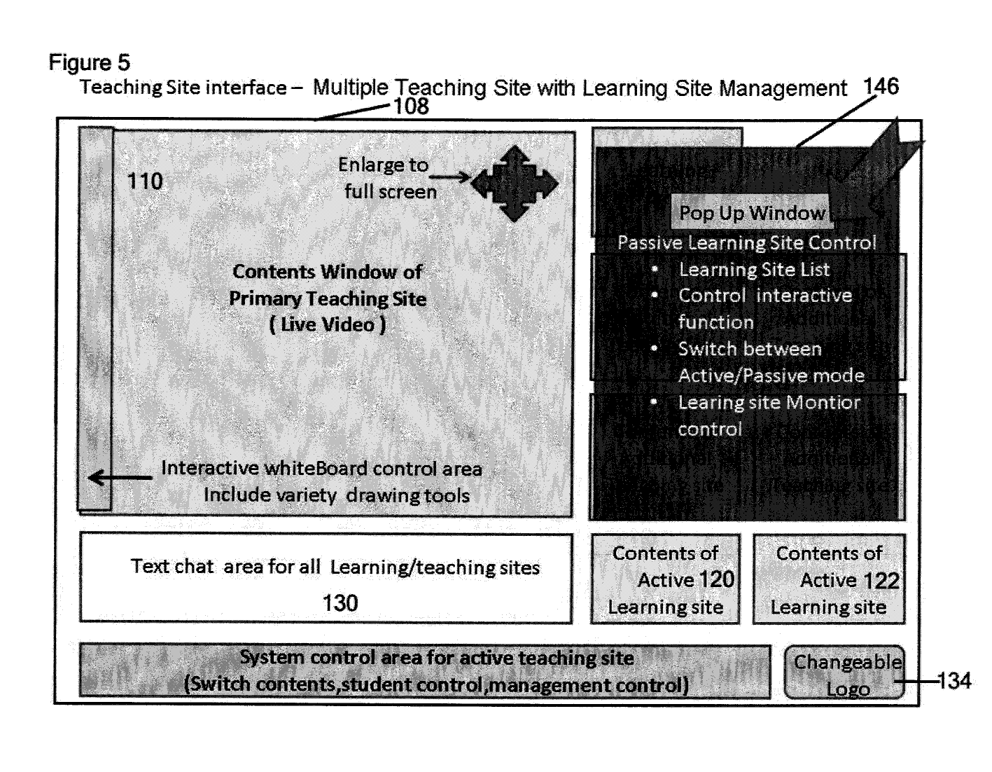

FIG. 5 is similar to FIGS. 3 and 4, but additionally depicting pop up window 146 (passive learning site control), viewable by teaching sites and wherein passive learning sites are controlled. For example, there is provided on this window: leanring site list, control interface functions, means to switch or toggle a site between a passive and active state (and vice versa), and means to monitor or control learning sites.

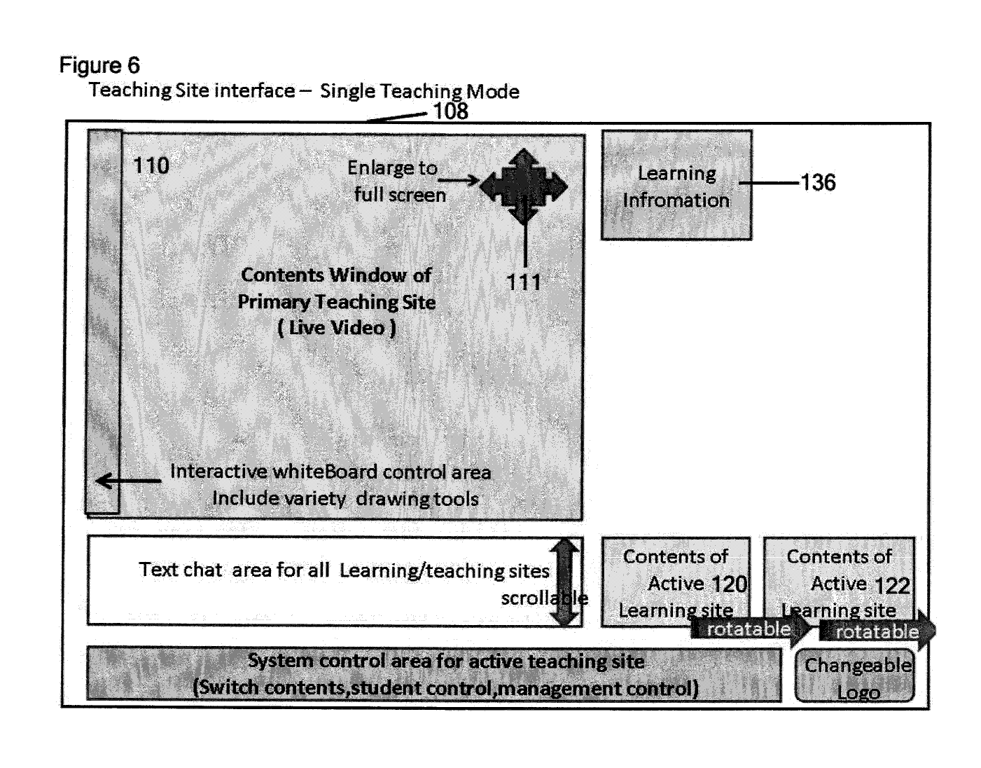

FIG. 6 depicts interface 108 in a single teaching mode, meaning primary teaching site display module 110 is the only teaching feed source.

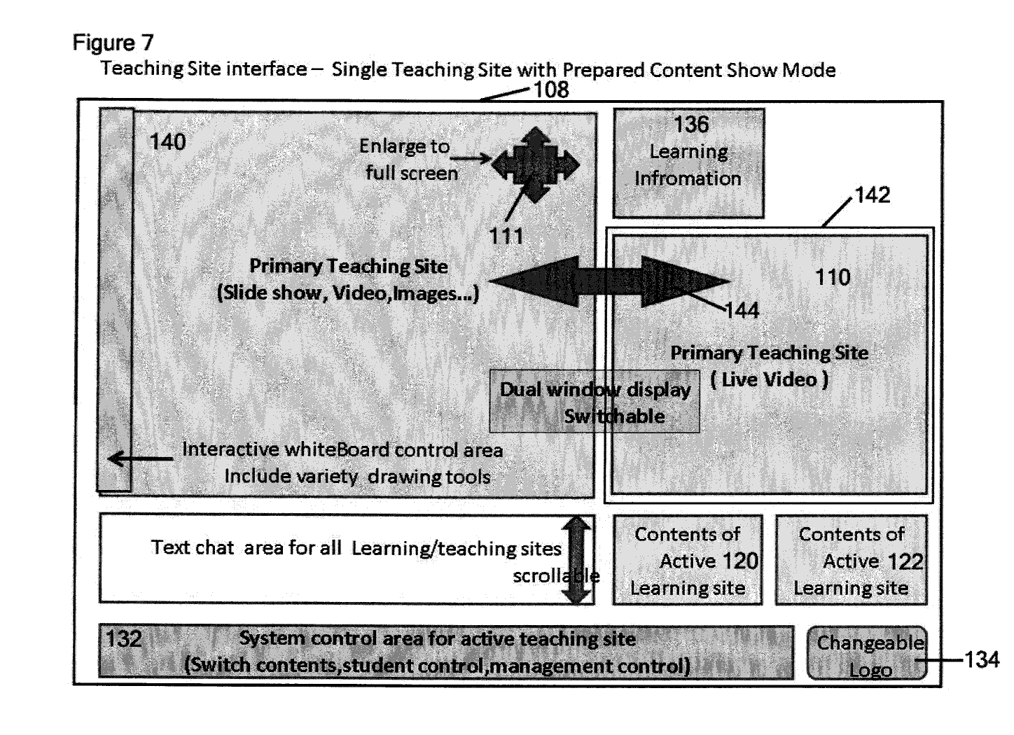

FIG. 7 interface 108 in a single teaching mode but having both live teaching and content delivered and switching or toggling between the two. Primary teaching site display module 110 (live content) switches with primary teaching site display module 140 (content mode). In a preferred form, primary teaching site display module 110 does not disappear as primary teaching site display module 140 (content mode) becomes more prominent on interface but rather toggles to a secondary position 142. In this way, as shown by arrow 144, window content display is “switchable” or capable being toggled between two viewing states on said interface. In this embodiment, there are no secondary teaching site display modules 112, 114, 116 and 118.

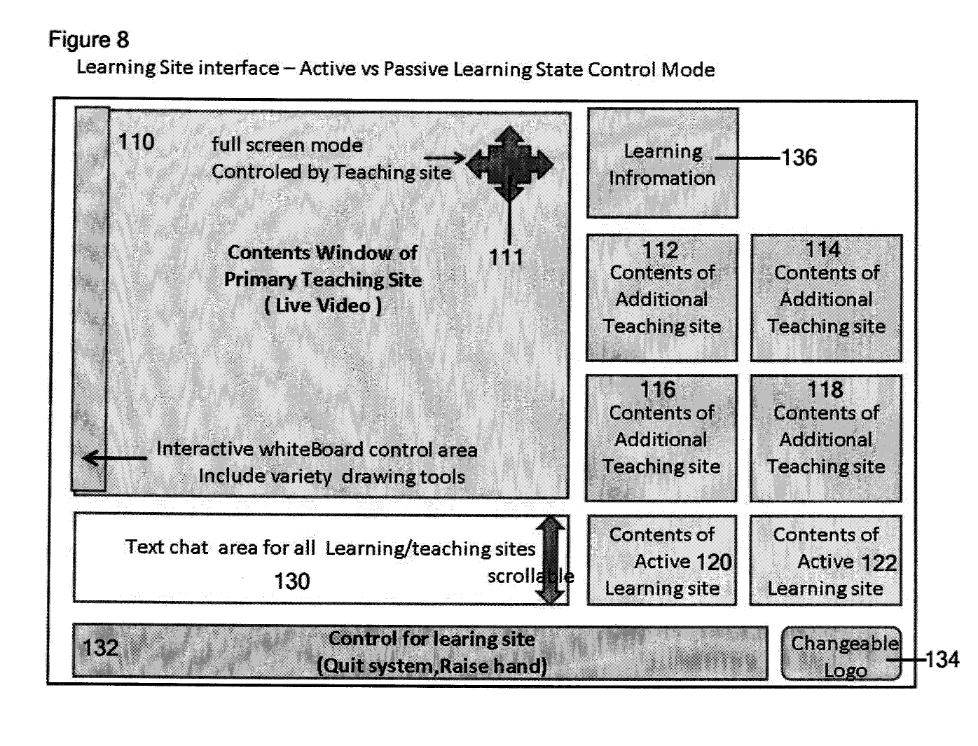

FIG. 8 depicts the modes of switching a learning site from a passive state to an active state using bar 132, which is a control area such that a passive site (previously communicating with a teaching site via hand raising function becomes a full active site with attendant communication abilities.

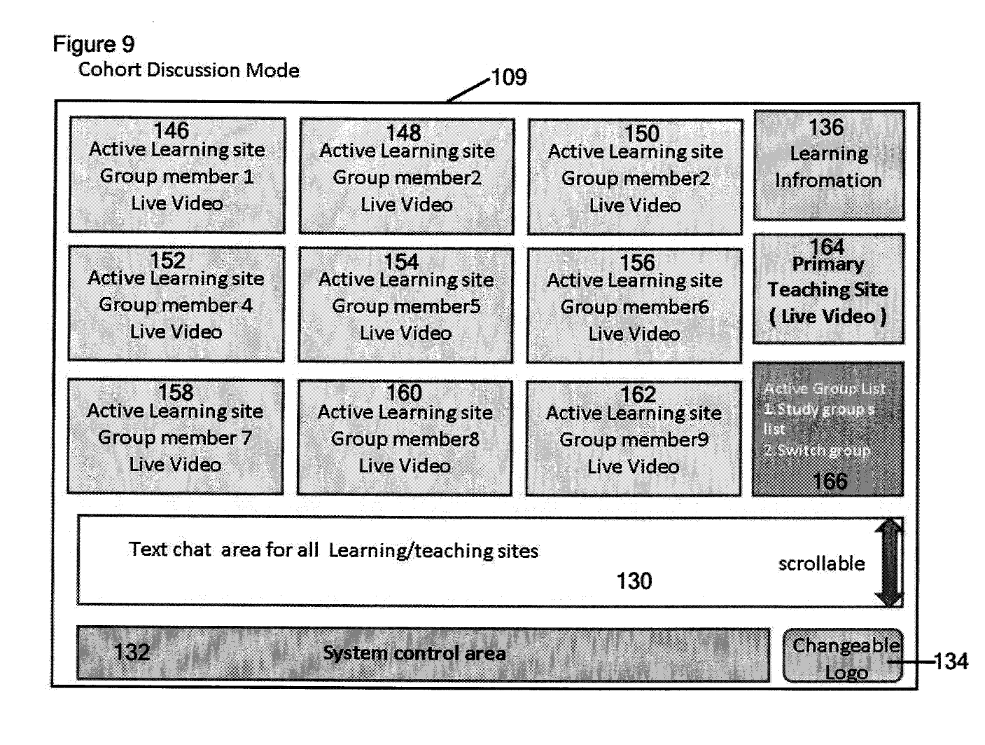

FIG. 9 shows interface 109 in cohort discussion mode. In this mode, there are nine active learning sites which are each cohorts in a active discussion grouping. Each of the nine is represented on interface 109 by its own module (146, 148, 150, 152, 154, 156, 160 and 162). Each of such modules is live for discussion and each site is viewable to the other sites and optionally/preferably to all teaching sites. In a most preferred form, there is provided a live facilitator for the cohort discussion mode, such facilitator being represented on interface 109 by module 164. In many cases, not all cohorts will be at active learning sites. List module 166 provides a handy list of all cohort sites, both active and passive. Control bar 132 allows management and control of data and switching of sites between active and passive states.

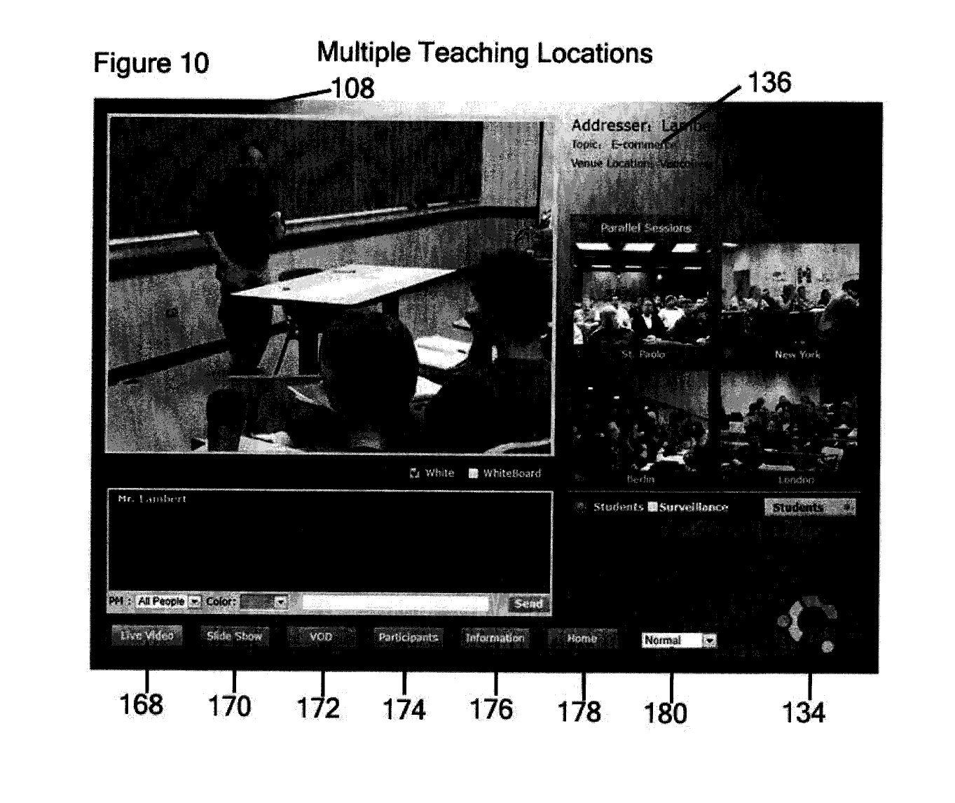

FIGS. 10-16 exemplify preferred website interfaces in live form, viewable by participants and enabling viewing of content and operation of the method and system of the present invention. Such interfaces are accessible by registering and then subsequently logging onto the website, as described herein. The elements in these figures can be readily matched back to similar numerated elements in FIGS. 3-9.

Additional features to be noted in these figures are:

In FIG. 10, (multiple teaching locations) the system control area is shown as a plurality of bars to be clicked:

Live video 168

Slide show 170

VOD 172

Participants 174

Information 176

Home 178

Other Settings 180

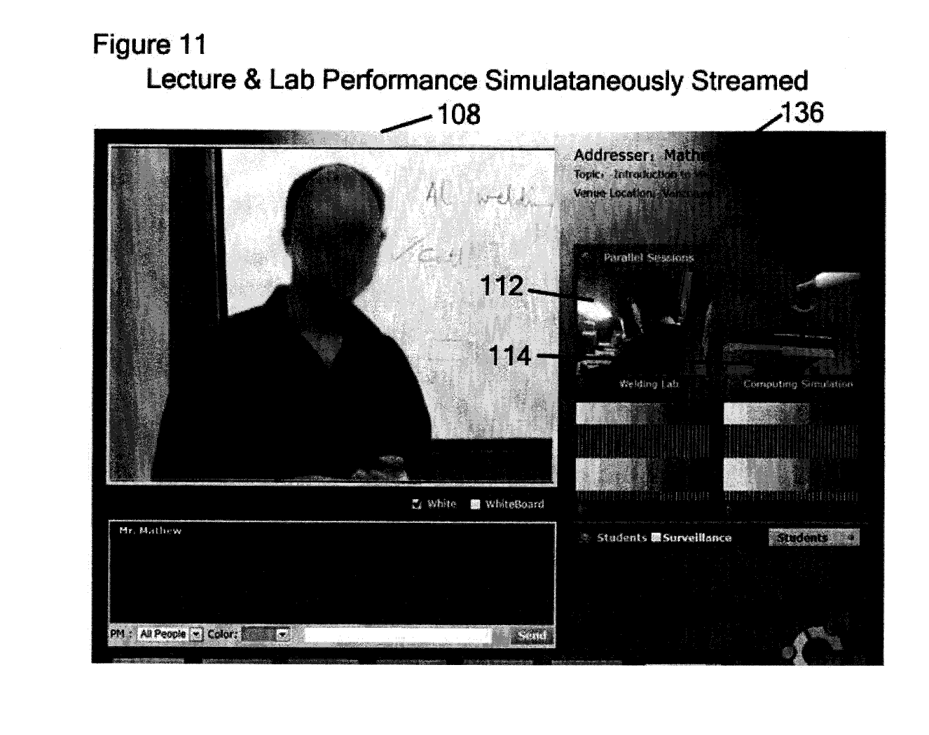

In FIG. 11, interface 108 shows the simultaneous streaming of a primary site and parallel additional teaching sites (in this case a welding lab and a simulation of the welding process being demonstrated). So, there is shown three complementary teaching sessions viewable by all participants. Primary teaching site display module 110 (live content) shows Mr. Mathews live, secondary teaching site display module 112 shows the welding demonstration and secondary teaching site display module 114 shows a computer simulation. In one preferred mode, Mr. Mathews and his teaching site remains in the primary 110 position and the other sites remain ancillary. In other embodiments, 110, 112 and 114 toggle for primary position.

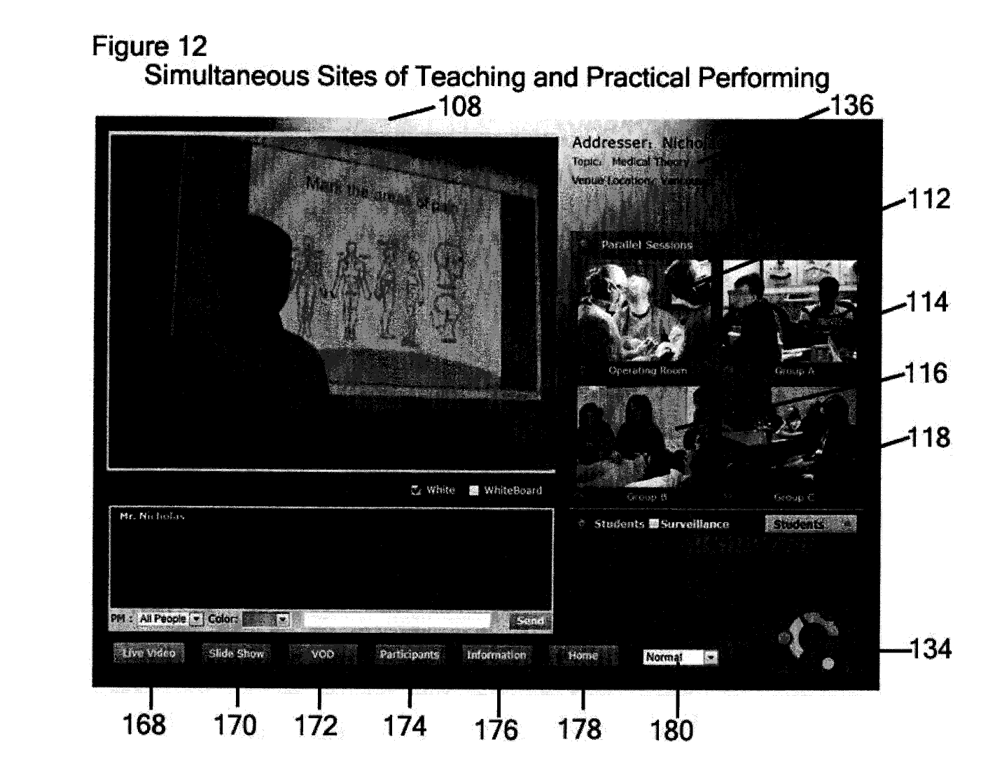

In FIG. 12, interface 108 shows the simultaneous streaming of a primary site and four parallel additional teaching sites (in this case an operating room, and four cohort teaching groups). So, there is shown five complementary teaching sessions viewable by all participants. Primary teaching site display module 110 (live content) shows Mr. Nicholas live, secondary teaching site display module 112 shows the operating room demonstration and secondary teaching site display modules 114, 116 and 118 show live group teaching sites. In one preferred mode, Mr. Nicholas and his teaching site remains in the primary 110 position and the other sites remain ancillary. In other embodiments, 110, 112, 114, 116 and 118 toggle for primary position.

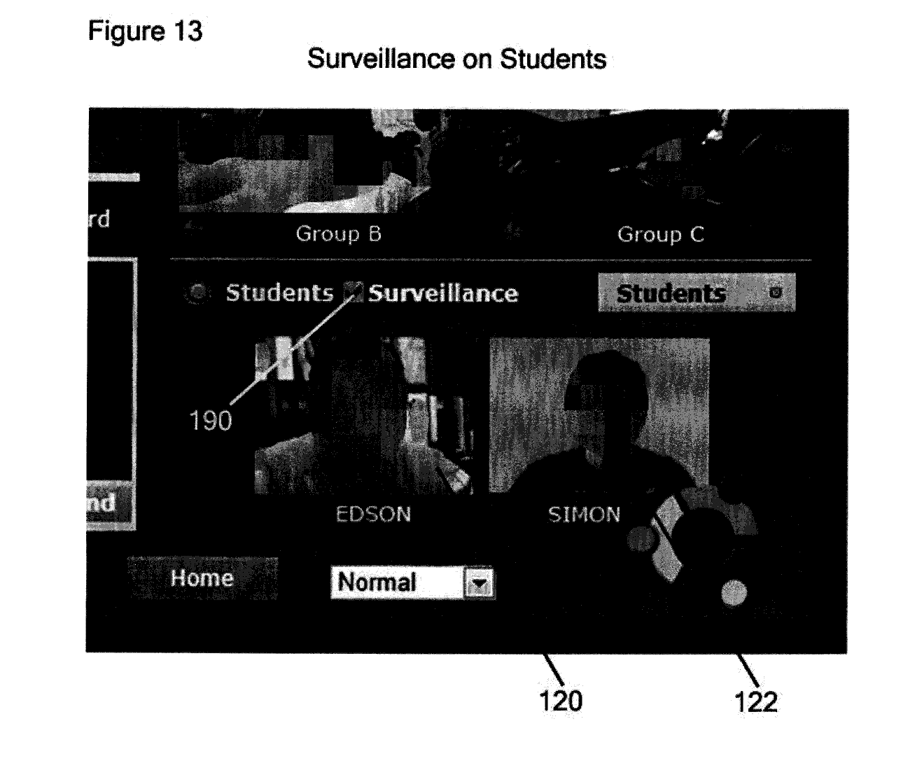

FIG. 13 is another depiction of interface 108 from FIG. 12, this time showing active live streaming of learning sites 120 and 122. Note that in this mode, surveillance box 190 is ticked such that active sites are viewable by both teaching sites and other active learning sites.

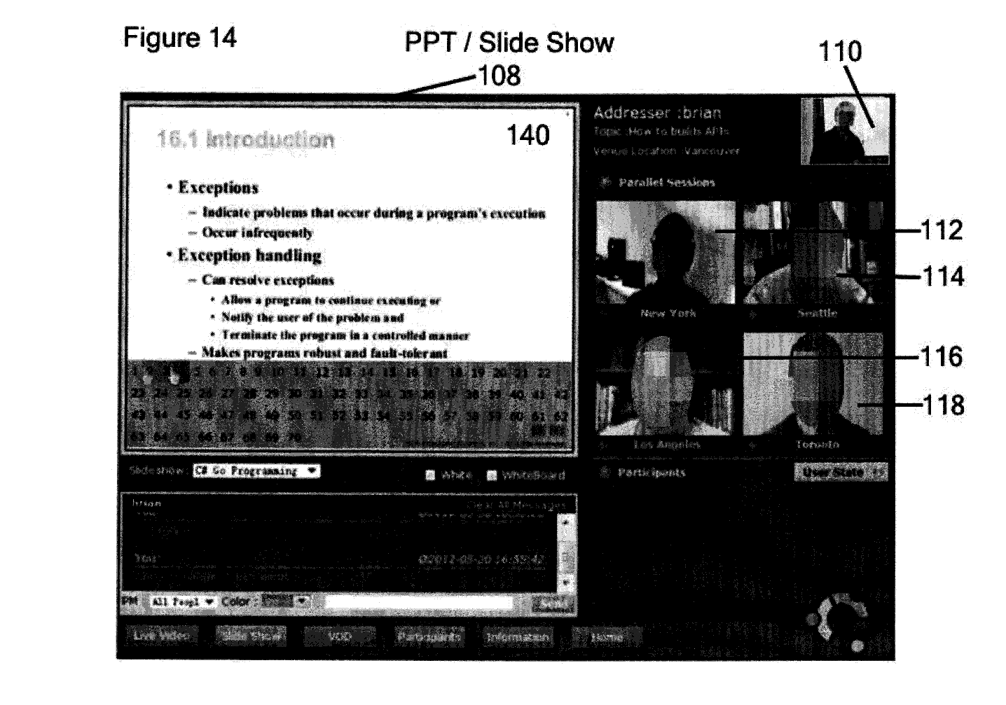

FIG. 14 shows a similar interface to FIG. 7 but with multiple additional teaching sites (not one). Interface 108 shows both live teaching from additional teaching sites (112, 114, 116 and 118) and content delivered at 140.

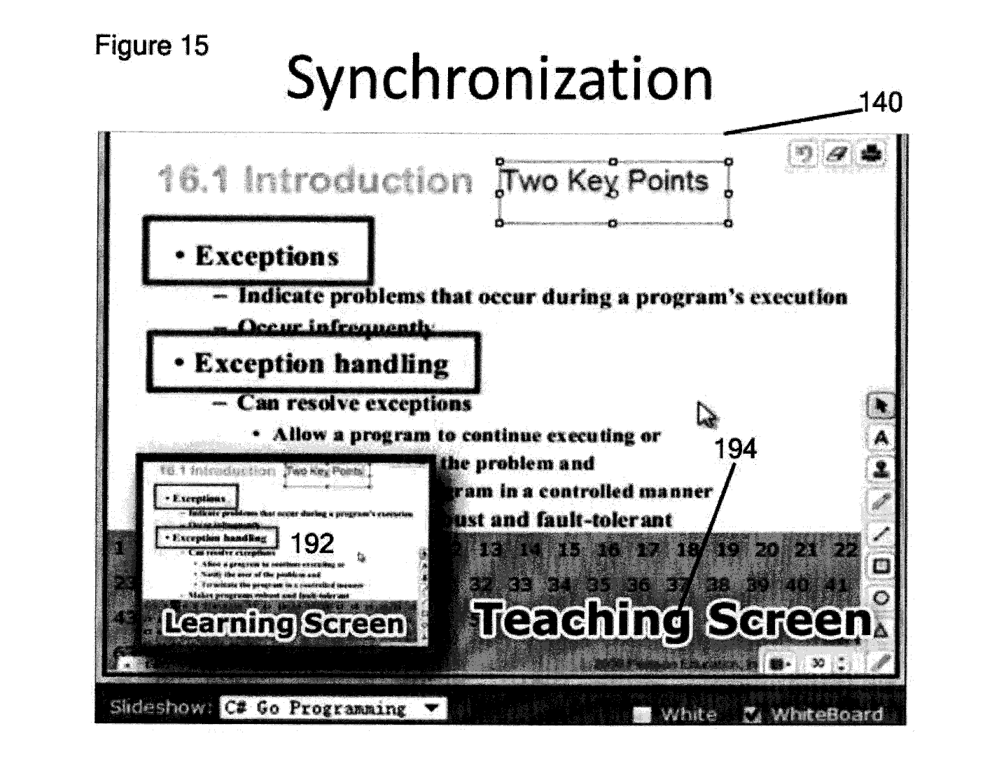

FIG. 15 is an expanded view of primary teaching site display module 140 (content mode) showing synchronization of learning screen 192 within teaching screen 194.

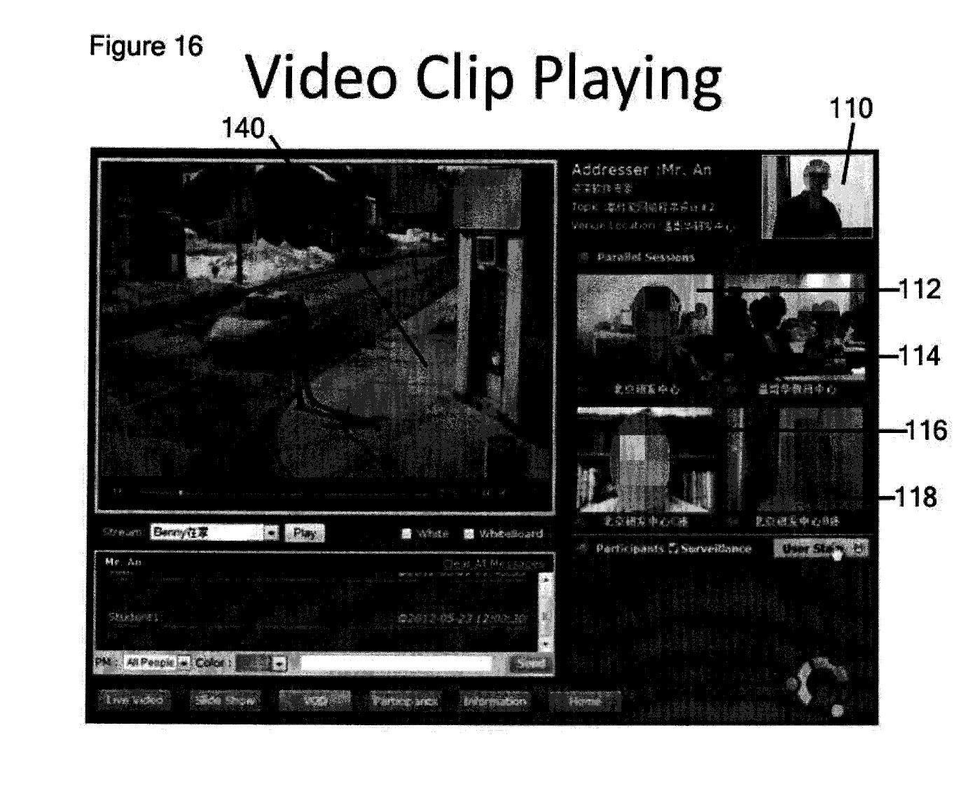

FIG. 16 is an alternative to FIG. 14 wherein primary teaching site display module 140 (content mode) delivers a video clip as opposed to a PPT/Slide Show.

The systems and methods described herein rely on a variety of computer systems, networks and/or digital devices for operation. As will be appreciated by those skilled in the art, computing systems and web-based cross-platforms include non-transitory computer-readable storage media for tangibly storing computer readable instructions. In order to fully appreciate how this preferably web-based cross-platform application and system operates an understanding of suitable computing systems is useful and is provided herein.

In one aspect, a computer system (or digital device), which may be understood as a logic apparatus adapted and configured to read instructions from media and/or network port, is connectable to a server and can have a fixed media. The computer system can also be connected to the Internet or an intranet. The system includes central processing unit (CPU), disk drives, optional input devices, such as a keyboard and/or mouse and optional monitor. Data communication can be achieved through, for example, communication medium to a server at a local or a remote location. The communication medium can include any suitable means of transmitting and/or receiving data. For example, the communication medium can be a network connection, a wireless connection or an Internet connection.

It is envisioned that data relating to the present disclosure can be transmitted over such networks or connections. The computer system can be adapted to communicate with a participant and/or a device used by a participant. The computer system is adaptable to communicate with other computers over the Internet, or with computers via a server. Each computing device (including mobile devices) includes an operating system (OS), which is software, that consists of software programs and data that runs on the devices, manages the device hardware resources, and provides common services for execution of various application software. The operating system enables an application program to run on the device.

As will be appreciated by those skilled in the art, a computer readable medium stores computer data, which data can include computer program code that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

A user launches an app created by an app creator and downloaded to the user's mobile device to view digital content items and can connect to a front end server via a network, which is typically the Internet, but can also be any network, including but not limited to any combination of a LAN, a MAN, a WAN, a mobile, wired or wireless network, a private network, or a virtual private network. As will be understood a very large numbers (e.g., millions) of users are supported and can be in communication with the website via an app at any time. The user may include a variety of different computing devices

Application delivery platform can be implemented entirely in hardware and/or a combination of hardware and/or software in execution. Further, application delivery platform can be incorporated within and/or associated with other compatible components. Additionally, application delivery platform can be, but is not limited to, any type of machine that includes a processor and/or is capable of effective communication with network topology and/or cloud. Illustrative machines that can comprise application delivery platform can include desktop computers, server class computing devices, laptop computers, notebook computers, Tablet PCs, consumer and/or industrial devices and/or appliances, hand-held devices, and the like.

Network topology and/or cloud can include any viable communication and/or broadcast technology, for example, wired and/or wireless modalities and/or technologies can be utilized to effectuate the claimed subject matter. Moreover, network topology and/or cloud 104 can include utilization of Personal Area Networks (PANs), Local Area Networks (LANs), Campus Area Networks (CANs), Metropolitan Area Networks (MANs), extranets, intranets, the Internet, Wide Area Networks (WANs)—both centralized and/or distributed—and/or any combination, permutation, and/or aggregation thereof. Furthermore, as those skilled in the art will appreciate and understand various data communications protocols (e.g., TCP/IP, Ethernet, Asynchronous Transfer Mode (ATM), Fiber Distributed Data Interface (FDDI), Fibre Channel, Fast Ethernet, Gigabit Ethernet, Wi-Fi, Token Ring, Frame Relay, etc.) can be utilized to implement suitable data communications.

Additionally application delivery server/platform may include a provisioning component that, based at least in part on input received from a portal component, can automatically configure and/or provision the various disparate mobile devices with appropriate applications.

It is to be appreciated that a store can be, for example, volatile memory or non-volatile memory, or can include both volatile and non-volatile memory. By way of illustration, and not limitation, non-volatile memory can include read-only memory (ROM), programmable read only memory (PROM), electrically programmable read only memory (EPROM), electrically erasable programmable read only memory (EEPROM), or flash memory. Volatile memory can include random access memory (RAM), which can act as external cache memory. By way of illustration rather than limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink® DRAM (SLDRAM), Rambus® direct RAM (RDRAM), direct Rambus® dynamic RAM (DRDRAM) and Rambus® dynamic RAM (RDRAM). Store 206 of the subject systems and methods is intended to comprise, without being limited to, these and any other suitable types of memory. In addition, it is to be appreciated that the store can be a server, a database, a hard drive, and the like.

### Server Modules, Components, and Logic

Certain embodiments are described herein as including logic or a number of modules, components or mechanisms. A module, logic, component or mechanism (hereinafter collectively referred to as a “module”) may be a tangible unit capable of performing certain operations and is configured or arranged in a certain manner. In example embodiments, one or more computer systems (e.g. server computer system) or one or more components of a computer system (e.g., a processor or a group of processors) may be configured by software (e.g., an application or application portion) as a “module” that operates to perform certain operations as described herein.

In various embodiments, a “module” may be implemented mechanically or electronically. For example, a module may comprise dedicated circuitry or logic that is permanently configured (e.g., within a special-purpose processor) to perform certain operations. A module may also comprise programmable logic or circuitry (e.g., as encompassed within a general-purpose processor or other programmable processor) that is temporarily configured by software to perform certain operations.

Accordingly, the term “module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiple of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation, and store the output of that operation in a memory device to which it is communicatively coupled. A further module may then, at a later time, access the memory device to retrieve and process the stored output. Modules may also initiate communications with input or output devices, and can operate on a resource (e.g., a collection of information).

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural and logical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

No embodiment of method steps or product elements described in the present application constitutes the invention claimed herein, or is essential to the invention claimed herein, or is coextensive with the invention claimed herein, except where it is either expressly stated to be so in this specification or expressly recited in a claim.

The invention can be implemented in numerous ways, including as a process, an apparatus, a system, a computer readable medium such as a computer readable storage medium or a computer network wherein program instructions are sent over optical or communication links. In this specification, these implementations, or any other form that the invention may take, may be referred to as systems or techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

The following discussion provides a brief and general description of a suitable computing environment in which various embodiments of the system may be implemented. Although not required, embodiments will be described in the general context of computer-executable instructions, such as program applications, modules, objects or macros being executed by a computer. Those skilled in the relevant art will appreciate that the invention can be practiced with other computing system configurations, including hand-held devices, multiprocessor systems, microprocessor-based or programmable consumer electronics, personal computers (“PCs”), network PCs, mini-computers, mainframe computers, mobile phones, personal digital assistants, smart phones, personal music players (like iPod) and the like. The embodiments can be practiced in distributed computing environments where tasks or modules are performed by remote processing devices, which are linked through a communications network. In a distributed computing environment, program modules may be located in both local and remote memory storage devices.

As used herein, the terms “computer” and “server” are both computing systems as described in the following. A computing system may be used as a server including one or more processing units, system memories, and system buses that couple various system components including system memory to a processing unit. Computing system will at times be referred to in the singular herein, but this is not intended to limit the application to a single computing system since in typical embodiments, there will be more than one computing system or other device involved. Other computing systems may be employed, such as conventional and personal computers, where the size or scale of the system allows. The processing unit may be any logic processing unit, such as one or more central processing units (“CPUs”), digital signal processors (“DSPs”), application-specific integrated circuits (“ASICs”), etc. Unless described otherwise, the construction and operation of the various components are of conventional design. As a result, such components need not be described in further detail herein, as they will be understood by those skilled in the relevant art.

The computing system includes a system bus that can employ any known bus structures or architectures, including a memory bus with memory controller, a peripheral bus, and a local bus. The system also will have a memory which may include read-only memory (“ROM”) and random access memory (“RAM”). A basic input/output system (“BIOS”), which can form part of the ROM, contains basic routines that help transfer information between elements within the computing system, such as during startup.

The computing system also includes non-volatile memory. The non-volatile memory may take a variety of forms, for example a hard disk drive for reading from and writing to a hard disk, and an optical disk drive and a magnetic disk drive for reading from and writing to removable optical disks and magnetic disks, respectively. The optical disk can be a CD-ROM, while the magnetic disk can be a magnetic floppy disk or diskette. The hard disk drive, optical disk drive and magnetic disk drive communicate with the processing unit via the system bus. The hard disk drive, optical disk drive and magnetic disk drive may include appropriate interfaces or controllers coupled between such drives and the system bus, as is known by those skilled in the relevant art. The drives, and their associated computer-readable media, provide non-volatile storage of computer readable instructions, data structures, program modules and other data for the computing system. Although computing systems may employ hard disks, optical disks and/or magnetic disks, those skilled in the relevant art will appreciate that other types of non-volatile computer-readable media that can store data accessible by a computer may be employed, such a magnetic cassettes, flash memory cards, digital video disks (“DVD”), Bernoulli cartridges, RAMs, ROMs, smart cards, etc.

Various program modules or application programs and/or data can be stored in the system memory. For example, the system memory may store an operating system, end user application interfaces, server applications, and one or more application program interfaces (“APIs”).

The system memory also includes one or more networking applications, for example a Web server application and/or Web client or browser application for permitting the computing system to exchange data with sources, such as clients operated by users and members via the Internet, corporate Intranets, or other networks as described below, as well as with other server applications on servers such as those further discussed below. The networking application in the preferred embodiment is markup language based, such as hypertext markup language (“HTML”), extensible markup language (“XML”) or wireless markup language (“WML”), and operates with markup languages that use syntactically delimited characters added to the data of a document to represent the structure of the document. A number of Web server applications and Web client or browser applications are commercially available, such as those available from Mozilla and Microsoft.

The operating system and various applications/modules and/or data can be stored on the hard disk of the hard disk drive, the optical disk of the optical disk drive and/or the magnetic disk of the magnetic disk drive.

A computing system can operate in a networked environment using logical connections to one or more client computing systems and/or one or more database systems, such as one or more remote computers or networks. The computing system may be logically connected to one or more client computing systems and/or database systems under any known method of permitting computers to communicate, for example through a network such as a local area network (“LAN”) and/or a wide area network (“WAN”) including, for example, the Internet. Such networking environments are well known including wired and wireless enterprise-wide computer networks, intranets, extranets, and the Internet. Other embodiments include other types of communication networks such as telecommunications networks, cellular networks, paging networks, and other mobile networks. The information sent or received via the communications channel may, or may not be encrypted. When used in a LAN networking environment, the computing system is connected to the LAN through an adapter or network interface card (communicatively linked to the system bus). When used in a WAN networking environment, the computing system may include an interface and modem (not shown) or other device, such as a network interface card, for establishing communications over the WAN/Internet.

In a networked environment, program modules, application programs, or data, or portions thereof, can be stored in the computing system for provision to the networked computers. In one embodiment, the computing system is communicatively linked through a network with TCP/IP middle layer network protocols; however, other similar network protocol layers are used in other embodiments, such as user datagram protocol (“UDP”). Those skilled in the relevant art will readily recognize that these network connections are only some examples of establishing communications links between computers, and other links may be used, including wireless links.

While in most instances the computing system will operate automatically, where an end user application interface is provided, an operator can enter commands and information into the computing system through an end user application interface including input devices, such as a keyboard, and a pointing device, such as a mouse. Other input devices can include a microphone, joystick, scanner, etc. These and other input devices are connected to the processing unit through the end user application interface, such as a serial port interface that couples to the system bus, although other interfaces, such as a parallel port, a game port, or a wireless interface, or a universal serial bus (“USB”) can be used. A monitor or other display device is coupled to the bus via a video interface, such as a video adapter (not shown). The computing system can include other output devices, such as speakers, printers, etc.

The present methods, systems and articles also may be implemented as a computer program product that comprises a computer program mechanism embedded in a computer readable storage medium. For instance, the computer program product could contain program modules. These program modules may be stored on CD-ROM, DVD, magnetic disk storage product, flash media or any other computer readable data or program storage product. The software modules in the computer program product may also be distributed electronically, via the Internet or otherwise, by transmission of a data signal (in which the software modules are embedded) such as embodied in a carrier wave.

For instance, the foregoing detailed description has set forth various embodiments of the devices and/or processes via the use of examples. Insofar as such examples contain one or more functions and/or operations, it will be understood by those skilled in the art that each function and/or operation within such examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, flash drives and computer memory; and transmission type media such as digital and analog communication links using TDM or IP based communication links (e.g., packet links).

Further, in the methods taught herein, the various acts may be performed in a different order than that illustrated and described. Additionally, the methods can omit some acts, and/or employ additional acts. As will be apparent to those skilled in the art, the various embodiments described above can be combined to provide further embodiments. Aspects of the present systems, methods and components can be modified, if necessary, to employ systems, methods, components and concepts to provide yet further embodiments of the invention. For example, the various methods described above may omit some acts, include other acts, and/or execute acts in a different order than set out in the illustrated embodiments.

These and other changes can be made to the present systems, methods and articles in light of the above description. In general, in the following claims, the terms used should not be construed to limit the invention to the specific embodiments disclosed in the specification and the claims, but should be construed to include all possible embodiments along with the full scope of equivalents to which such claims are entitled. Accordingly, the invention is not limited by the disclosure, but instead its scope is to be determined entirely by the following claims.

While certain aspects of the invention are presented below in certain claim forms, the inventors contemplate the various aspects of the invention in any available claim form. For example, while only some aspects of the invention may currently be recited as being embodied in a computer-readable medium, other aspects may likewise be so embodied.

### Example

### System Description

Live School: a computer system that consists of many subject matters to be taught in different classrooms at either the same time or at different time. In each subject matter, it include the following:
   Classrooms
      Primary teaching site
      Secondary teaching site
   Participants
      Active learners
      Passive learners
      Teacher(s)
      Teaching Assistants (TA)
   Chatroom
      Class chatroom
      TA chatroom
      Learner Chatroom
   Resource Room
      Whiteboard
      Slide
      Power Point
      Video
      Publication
      TA chatroom
      Bulletin board
   Control Room
      Learner Monitoring
      Primary-secondary classroom switch
      Active-passive learner switch
      Whiteboard control
      Slide control
      PPT control
      Video control
      Publication control
      Chatroom control
         Classroom: a live video and audio channel streamed in a similar format of traditional classroom
Primary classroom
   Take major representation space of live teaching via main computer screen
   Only one primary screen content in a live class
Secondary classroom
   Take minor representation space of live teaching via main computer screen
   Multiple secondary classrooms in a live delivery
Participants: a learner, an observer, or a teacher participates a live teaching and learning environment
Active Learner
   One who has a live video and audio channel presented in the teaching screen
   Multiple learners in the active state in a live delivery
Passive Learner
   One who receives the live content without his/her own video and audio channel presented in the live main computer screen
   Massive (up to the order of millions of online learners) passive learners in the live delivery with the functionality that they have instant interactions with at least one teaching site via text chat
Teachers
   Those who teach in the first and additional teaching sites
   Each class has one or more teachers
Teacher Assistant
   One who manages resource and control rooms without his/her own video and audio channel presented during the delivery
   One who manage and respond to text chat with passive learners
   Multiple TAs in a live delivery with massive learners
Observer/Administrator
   One who observes the class delivery for quality assurance without being seen by neither the teachers, TAs, nor the learners.
   Multiple Observers invisible (or visible for specific need) during the teaching and learning process
Chatroom: an interactive text chat message computer screen in a live delivery
Class chatroom
   Takes a part of representation space of the main computer screen
   Support to all learners and teachers who chat respectively
   All participants automatically join in class chatroom
TA chatroom
   A subscreen outside the main computer screen
   Support public and one-to-one private chat
   Owned by one or more TAs
   Learners can selectively join one or more TA chatrooms
Resource Room: a computer sub-screen in the main screen
Whiteboard, Slide show, PPT, Video clip, audio file etc
   A video channel selectively presented by a teacher during a live class teaching session
   Participates can selectively watch, pause and hide them
Publication
   Preload teaching materials
   Participates can selectively download publications
TA chatroom
   Chatrooms controlled by TA
   Participants can selectively join TA chatrooms
Bulletin Board
   Content abstract
   Announcement given by teachers and TAs
   Raise hand function
   Help button
Control Room: a computer sub-screen in a live class viewable only by teachers and TAs
Learner Monitoring
   Multiple participants video and audio channels
   Selectively chosen from all participants
Primary-Secondary classroom switch
   Switch functioning between primary and secondary-classes
Active-passive state switch of learners
   Switch functioning between active and passive learners
Whiteboard control
   Manage whiteboard
Slide show control
   Manage slide show
Power Point Presentation control
   Manage PPT Presentation
Video clip and audio file control
   Manage video show and/or audio file play
Publication control
   Manage teaching materials
Chatroom control
   Manage chatroom

We claim:

1. A system for delivering distance learning which enables a plurality of teaching sites to be streamed to multiple locations via a network with instant, real time information conveyance and instant interaction between at least one teacher at least one of said teaching sites and at least one learner at least one learning site via video images, audio signals, whiteboard functions, and other text chat messaging and other digital signal modes which comprises:
a) a first teaching site with screen content on an website interface (first screen content);
b) more than one additional teaching site with screen content on a website interface (secondary screen content, tertiary screen content . . . );
c) more than one learning site at remote locations from both the first teaching site and the additional teaching sites, said learning sites enabled to i) receive information conveyed from the first teaching site and the additional teaching sites and ii) send information back to the first teaching site, the additional teaching sites and the learning sites;
d) a server (or a series of servers, forming a “server system”) for managing registration and log in via the network, of first teaching site, additional teaching sites and learning sites to the website, synchronizing information, real time conveyance of information from, content delivery to and from and interaction and communication by and between:
i) the first teaching site to the learning sites
ii) the first teaching site to the additional teaching sites
iii) the additional teaching site to the learning sites;
iv) the additional teaching sites to the first teaching site;
v) the learning sites to the first teaching site and more than one additional teaching sites;
vi) between the additional teaching sites; and
vii) between one learning site and other learning sites;
wherein a learning site is transformable from a passive learning state to an active learning state in relation to both the first teaching site and the additional teaching sites, such transformation being controllable and dynamically alterable by at least one of the first teaching site and the additional teaching sites;
wherein a learning site in the active learning state i) has screen content on the website interface (active learning site screen content), such active learning site screen content being viewable by a teacher at one of the first teaching site and more than one additional teaching sites and ii) is enabled to actively engage with the first teaching site and more than one additional teaching sites via at least one of the following, alone or in combination: instant communications through two way video images, audio signals, whiteboard functions, and text chat messaging.

2. The system of claim 1 wherein a learning site comprises a single learner.

3. The system of claim 1 wherein a learning site comprises a plurality of learners.

4. The system of claim 1 wherein the network is internet or intranet or the combination of both.

5. The system of claim 1 comprising a plurality of learning sites.

6. The system of claim 1 wherein at least one of the first teaching site and the additional teaching sites comprise a learner or a group of learners.

7. The system of claim 1 wherein both the first teaching site and the additional teaching sites comprise teachers and no learners.

8. The system of claim 1 wherein the first teaching site conveys theoretical teaching on a subject and the additional teaching sites comprise practical teaching on that subject and wherein all teaching sites simultaneously convey co-ordinated real time information to the learners, the conveyance of which is controlled by the server system.

9. The system of claim 1 wherein a learning site comprises an image capture device which creates a learner site image, and wherein the system comprises a means to convey the learning site image to the server, via the network, said learner site image being viewable as active learning site screen content on the website interface to all the teaching sites and all the other learning sites of both passive and active states, when the learning site is in an active learning state.

10. The system of claim 9 comprising more than one learning sites in the active learning state which dynamically interacts in real time with at least one of the first teaching site and the additional teaching sites via video images, audio signals, whiteboard functions, and other messaging modes such as the online text chat.

11. The system of claim 9 comprising more than one learning sites in the passive learning state, such state adapted only to receive content at the learning site and to communicate via text chat messages from the learning sites to the designated teaching sites.

12. The system of claim 1 wherein screen content comprises digital data that are in the form of the video images, audio signals, whiteboard functions, preloaded materials such as slides, power point presentations, text chat messages etc.

13. The system of claim 1 comprising as many teaching sites and active learning sites as needed, provided the system is restricted by either the bandwidth of the internet or intranet, or the physical size of the viewing screen.

14. The system of claim 9 comprising a surveillance function that enables the teaching sites and learning sites to monitor individual learning sites with video and audio images on the rotational basis.

15. The system of claim 9 comprising a teaching site with a teaching assistant, which assistant interacts with passive learning sites through instant text chat messages.

16. The system of claim 1 comprising a great deal of passive learning sites in the order of magnitude from one hundred thousand to one million.

17. The system of claim 1 comprising learning sites in the active learning state which state allows: i) interaction in real time between the learning site and a teacher at the first teaching site and at at least one additional teaching sites via two-way video images; ii) interaction with a teacher at the first teaching site and at at least one additional teaching site via two-way audio signals; iii) interaction with a teacher at the first teaching site and at at least one additional teaching site via the online text chat; iv) interaction with a teacher at the first teaching site and at least one additional teaching site via the whiteboard functions; v) review or replay the uploaded recording lessons as personal additional learning experience to meet the individual needs.

18. The system of claim 1 wherein a learning site is transformable from a passive learning state to an active learning state in relation to the teaching sites, such transformation being either controllable and dynamically alterable by a learner at a passive learning site or such transformation being controllable and dynamically alterable by the server or the series of servers forming a server system based on a set of pre-defined criteria.

19. A computer implemented method for delivering distance learning which enables a plurality of teaching sites to be streamed to multiple locations via a network with instant, real time information conveyance between at least one teacher at at least one of said teaching sites and at least one learner at at least one learning site via video images, audio signals, whiteboard, and other messaging modes which comprises:
a) connecting, via a network, and with permission of a server system, a first teaching site, more than one additional teaching site (said additional teaching sites at remote locations from the first teaching site) and more than one learning site (said learning sites at remote locations from both the first teaching site and the additional teaching sites);
b) providing dynamic live data from the first teaching site to the additional teaching sites and the learning sites in accordance with requests to the server system;
c) providing dynamic live data from the additional teaching sites to the first teaching site and the learning sites in accordance with requests to the server system;
d) providing dynamic live data from the learning sites to the first teaching site and the additional teaching sites in accordance with requests to the server system;
e) synchronizing information, real time conveyance of information from, content delivery to and from and communication by and between:
i) the first teaching site to the learning sites
ii) the first teaching site to the additional teaching sites
iii) the additional teaching sites to the learning sites;
iv) the additional teaching sites to the first teaching site;
v) the learning sites to the first teaching site and the additional teaching sites;
vi) between one additional teaching site and another additional teaching site; and
vii) between one learning site and other learning sites;
f) transforming at least one learning site from a passive learning state to an active learning state in relation to at least one of the first teaching site and the additional teaching sites, such transformation being controlled and dynamically altered by the first teaching site and at least one additional teaching sites, wherein a learning site in the active learning state i) has screen content on a website interface (active learning site screen content), such active learning site screen content being viewable by a teacher at the first teaching site and at least one additional teaching sites and ii) is enabled to actively engage with the first teaching site and at least one additional teaching sites through at least one of the following, alone or in combination: real-time video, audio and text interactions.

20. The method of claim 19 wherein the learning site comprises a single learner.

21. The method of claim 19 wherein the learning site comprises a plurality of learners.

22. The method of claim 19 wherein the network is internet or intranet or the combination of both.

23. The method of claim 19 comprising a plurality of learning sites.

24. The method of claim 19 wherein the first teaching site and the additional teaching sites comprise a learner or a group of learners.

25. The method of claim 19 wherein both the first teaching site and the additional teaching sites comprise teachers and no learners.

26. The method of claim 19 wherein the first teaching site provides data on theoretical teaching on a subject and the additional teaching sites provide data on practical teaching on that subject and wherein all teaching sites simultaneously convey co-ordinated real time information to the learners, the conveyance of which is controlled by the server system.

27. The method of claim 19 which comprises populating an interface with screen content from the first teaching site (first screen content) and screen content to the additional teaching sites (secondary screen content, tertiary screen content . . . ) said interface being viewable by the teacher(s) at the first teaching site and at the additional teaching sites, and a learner or a group of learners at their respective learning sites.

28. The method of claim 19 which comprises dynamically capturing live images (video, audio, whiteboard, text chat etc.) of a learner at a learning site when the learning site is in the active learning state and conveying such images to all of the teaching sites and all the learning sites in both active and passive states.

29. The method of claim 19 which comprises dynamically capturing live images (video, audio, whiteboard, and text chat) from both teaching sites and the learning sites and conveying all such images to an observing and administration site for quality assurance and assessment of the teacher.

30. A method of monitoring a learner at a learning site by one or more of a first teaching site, additional teaching sites and other learning sites which comprises enabling surveillance of the learner via an image capture device, capturing live images of the learner from the image capture device and conveying such live images, via a server or server system to the first teaching site, the additional teaching sites and other learning sites, such live images being viewable on an interface at each site.

31. A computer implemented method for connecting at least one learner at a learning site seeking deliverance of live distance learning data simultaneously from a teacher at first remote teaching site and a teacher at more than one remote teaching sites, such data being coordinated in its delivery between the first remote teaching site and the remote teaching sites and the learning sites which comprises:
a) receiving, from the first teaching site, requests to establish electronic relationships with more than one additional teaching sites and more than one learning sites;
b) providing data corresponding to the requests to a server system; and
c) receiving from the server system live (dynamic or static) data and communications provided by the first teaching site, the additional teaching sites and by the learning sites, wherein the data and communications have been selected by the server system to be delivered in real time only by and between those sites which have requested and accepted relationships.

32. The method of claim 31 wherein the deliverance of live distance learning data is over a network which is at least one of internet or intranet or combination of both.

33. The method of claim 31 comprising a learning site in the active learning state which dynamically interacts in real time with at least one of the first teaching site and the additional teaching sites via video images, audio signals, whiteboard, and other text chat messaging modes.

34. The method of claim 31 comprising a learning site in the passive learning state, such state adapted to receive content at the learning site and to correspond to real time text chat messages from the learning site to the teaching sites.

35. A networked apparatus for use by at least one learner at a learning site in live communication for receiving data coordinated from a plurality of remote teaching sites comprising: a memory; a processor; a communicator; a display; a data receiving module to receive (alone or in combination) video images, audio signals, whiteboard, and text chat messages from the teaching sites, via a central server system, and an image capture device which creates a learner site image, and wherein the apparatus comprises a means to convey the learning site image to the server system, via a network, said learner site image being intermittently viewable on a website interface to both the teaching sites and a plurality of learning sites

36. A networked apparatus for use by at least one teacher at a teaching site in live communication for sending data to a plurality of remote learning sites and additional teaching sites comprising: a memory; a processor; a communicator; a display; a data sending and receiving module to send and receive at least one of the following, alone or in combination: video images, audio signals, whiteboard and text chat messages, via a central server system, to a plurality of remote learning sites and additional teaching sites, a display for receiving, via the server system, images captured from at least one learning site and a website interface to toggle a learning site between an active learning state and a passive learning state, wherein said active learning state provides for: i) interaction between the learning site and a teacher at the first teaching site and at the at least one additional teaching site via two-way video images; ii) interaction between the learning site and with a teacher at the first teaching site and at the at least one additional teaching site via two-way audio; iii) interaction between the learning site and with a teacher at the first teaching site and at the at least one additional teaching site via whiteboard communication; and iv) interaction between the learning site and with a teacher at the first teaching site and at the at least one additional teaching site via text chat messaging.

37. A non-transitory, computer-readable storage media for tangibly storing thereon computer readable instructions for a method for delivering distance learning which enables a plurality of teaching sites to be streamed to multiple locations via a network with instant, real time information conveyance between a teacher at least one of said teaching sites and a learner at a learning site via video images, audio signals, and other messaging modes which comprises:
a) connecting, via a network, and with permission of a server system, a first teaching site, at least one additional teaching site (said additional teaching sites at remote locations from the first teaching site) and at least one learning site (said learning site at a remote location from both the first teaching site and the additional teaching sites);
b) providing dynamic live data from the first teaching site to the additional teaching sites and the learning site in accordance with requests to the server system;
c) providing dynamic live data from the additional teaching sites to the first teaching site and the learning site in accordance with requests to the server system;
d) providing dynamic live data from the learning sites to the first teaching site and the additional teaching sites in accordance with requests to the server system;
e) synchronizing information, real time conveyance of information from, content delivery to and from and communication by and between:
i) the first teaching site to the learning sites;
ii) the first teaching site to the additional teaching sites;
iii) the additional teaching site to the learning site;
iv) the additional teaching sites to the first teaching site;
v) the learning site to the first teaching site and the additional teaching site;
vi) between additional teaching sites; and
vii) between one learning site and other learning sites;
f) transforming the learning site from a passive learning state to an active learning state in relation to the first teaching site and at least one additional teaching site, such transformation being controlled and dynamically altered by the first teaching site and at least one additional teaching site, wherein a learning site in the active learning state i) has screen content on a website interface (active learning site screen content), such active learning site screen content being viewable by a teacher at the first teaching site and at the at least one additional teaching site and ii) is enabled to actively engage with the first teaching site and the additional teaching sites through at least one of the following, alone or in combination: real-time video, audio, whiteboard and text chat interactions

38. An interface which is viewable by participants at an observer site, such observer site being optionally non-viewable on said interface by other participants (teaching and learning sites) and controlled by a server or sever system.

39. An interface which is viewable by participants at a first teaching site, an additional teaching site and a learning site (wherein those sites are networked to engage with a server or server system) wherein said interface comprises:
a module (a segment of the interface) for display of live content delivered from the first teaching site, such content being viewable by all participants (primary teaching site display module);
one or more modules (segment of the interface) for display of live content delivered from each additional teaching site(s), such content being viewable by all participants (each a secondary teaching site display modules); and
a module (a segment of the interface) for display of live content delivered from an active learning site such content being viewable by all participants (each a learning site display module).
